(19) United States
(12) Patent Application Publication
(10) Pub. No.: US 2025/0191482 A1
(43) Pub. Date: Jun. 12, 2025

(54) WORK ANALYSIS DEVICE, WORK ANALYSIS SYSTEM, WORK ANALYSIS METHOD, AND STORAGE MEDIUM

(71) Applicants: NEC Corporation, Minato-ku, Tokyo (JP); NEC Solution Innovators, Ltd., Koto-ku, Tokyo (JP)

(72) Inventors: Takashi NONAKA, Tokyo (JP); Kenichi WAKABAYASHI, Tokyo (JP); Hiroaki YANAGISAWA, Tokyo (JP)

(73) Assignees: NEC Corporation, Minato-ku, Tokyo (JP); NEC Solution Innovators, Ltd., Koto-ku, Tokyo (JP)

(21) Appl. No.: 18/845,957

(22) PCT Filed: Mar. 16, 2022
(86) PCT No.: PCT/JP2022/012066

§ 371 Date: Sep. 11, 2024

(51) Int. Cl. G09B 5/02; G01P 13/00; G06F 3/01

(52) U.S. Cl. CPC G09B 5/02; G01P 13/00; G06F 3/011; G06F 2203/011

(57) ABSTRACT

A work analysis device acquires data representing motions that have been detected by a VR device that presents a plurality of work items of a problem in a virtual space, and which are made by a user of the VR device to perform the plurality of work items in the virtual space, and data representing a line of sight direction of the user of the VR device. The work analysis device generates and stores time-series data of the motions made by the user of the VR device from the data representing the motions made by the user of the VR device to perform the plurality of work items in the virtual space. The work analysis device generates and stores time-series data of the line of sight direction of the user of the VR device from the data representing the line of sight direction of the user.

### TECHNICAL FIELD

The present invention relates to a work analysis device, a work analysis system, a work analysis method, and a recording medium.

### BACKGROUND ART

Patent Document 1 describes a technique that generates and passes on an optimal motion for efficiently performing a work item. In the technique described in Patent Document 1, information relating to a person's motion from the start to finish of a work item is recorded as work item data. Then, the entire motion from the start to finish of the work item is divided into a plurality of partial motions, and the best partial motion is selected for each partial motion from a plurality of samples of work item data for the same work item to synthesize the best partial motion.

Patent Document 2 describes a content creation system that creates training content for executing a simulated work item. In the technique described in Patent Document 2, three-dimensional work item motions of a simulated operator that executes the work items of a work item procedure are acquired as measurement information. Then, evaluation criteria information for the work items of the work item procedure is created based on the measurement information of the three-dimensional work item motions, and the training content is created and updated based on the measurement information of the three-dimensional work item motions, the evaluation criteria information, and three-dimensional shape information of a work item target device.

### PRIOR ART DOCUMENTS

### Patent Documents

Patent Document 1: PCT International Publication No. WO2017/159562
Patent Document 2: Japanese Unexamined Patent Application, First Publication No. 2020-003707

### SUMMARY OF THE INVENTION

### Problems to be Solved by the Invention

Patent Document 1 describes displaying a video reproduction of an operator's motions. Further, Patent Document 2 describes the recording of changes in the motions, the line of sight, and the like. However, in the techniques described in Patent Documents 1 and 2, the changes in the operator's motions or line of sight direction are not visualized (such as by generating a trajectory). As a result, the techniques described in Patent Documents 1 and 2 cannot efficiently search for an optimal procedure to perform a plurality of work items.

Therefore, an example object of the present invention is to provide a work analysis device, a work analysis system, a work analysis method, and a recording medium that solve the above problem.

### Means for Solving the Problem

According to a first example aspect of the present invention, a work analysis device includes: an acquisition means that acquires data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device; a storage means that generates and stores time-series data of the motions made by the user of the VR device from the data representing the motions made by the user of the VR device to perform the plurality of work items in the virtual space that has been acquired by the acquisition means, and generates and stores time-series data of the line of sight direction of the user of the VR device from the data representing the line of sight direction of the user of the VR device that has been acquired by the acquisition means; an analysis means that visualizes changes in the motions made by the user of the VR device to perform the plurality of work items in the virtual space based on at least the time-series data of the motions made by the user of the VR device that is stored in the storage means, and visualizes changes in the line of sight direction of the user of the VR device based on the time-series data of the line of sight direction of the user of the VR device that is stored in the storage means; and an output means that outputs an analysis result by the analysis means.

According to a second example aspect of the present invention, a work analysis system includes: a VR device that presents a plurality of work items of a problem in a virtual space; and a work analysis device that analyzes the plurality of work items performed by a user of the VR device, wherein the VR device detects motions that are made by the user of the VR device to perform the plurality of work items in the virtual space, and a line of sight direction of the user of the VR device, and the work analysis device includes: an acquisition means that acquires data representing motions that have been detected by the VR device and which are made by the user of the VR device to perform the plurality of work items in the virtual space, and data representing a line of sight direction of the user of the VR device that has been detected by the VR device; a storage means that generates and stores time-series data of the motions made by the user of the VR device from the data representing the motions made by the user of the VR device to perform the plurality of work items in the virtual space that has been acquired by the acquisition means, and generates and stores time-series data of the line of sight direction of the user of the VR device from the data representing the line of sight direction of the user of the VR device that has been acquired by the acquisition means; an analysis means that visualizes changes in the motions made by the user of the VR device to perform the plurality of work items in the virtual space based on at least the time-series data of the motions made by the user of the VR device that is stored in the storage means, and visualizes changes in the line of sight direction of the user of the VR device based on the time-series data of the line of sight direction of the user of the VR device that is stored in the storage means; and an output means that outputs an analysis result by the analysis means.

According to a third example aspect of the present invention, a work analysis method includes: an acquisition step of acquiring data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device; a storage step of generating and storing time-series data of the motions made by the user of the VR device from the data representing the motions made by the user of the VR device to perform the plurality of work items in the virtual space that has been acquired in the acquisition step, and generating and storing time-series data of the line of sight direction of the user of the VR device from the data representing the line of sight direction of the user of the VR device that has been acquired in the acquisition step; an analysis step of visualizing changes in the motions made by the user of the VR device to perform the plurality of work items in the virtual space based on at least the time-series data of the motions made by the user of the VR device that has been stored in the storage step, and visualizing changes in the line of sight direction of the user of the VR device based on the time-series data of the line of sight direction of the user of the VR device that has been stored in the storage step; and an output step of outputting an analysis result in the analysis step.

According to a fourth example aspect of the present invention, a recording medium that stores a program causes a computer to execute the steps of: an acquisition step of acquiring data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device; a storage step of generating and storing time-series data of the motions made by the user of the VR device from the data representing the motions made by the user of the VR device to perform the plurality of work items in the virtual space that has been acquired in the acquisition step, and generating and storing time-series data of the line of sight direction of the user of the VR device from the data representing the line of sight direction of the user of the VR device that has been acquired in the acquisition step; an analysis step of visualizing changes in the motions made by the user of the VR device to perform the plurality of work items in the virtual space based on at least the time-series data of the motions made by the user of the VR device that has been stored in the storage step, and visualizing changes in the line of sight direction of the user of the VR device based on the time-series data of the line of sight direction of the user of the VR device that has been stored in the storage step; and an output step of outputting an analysis result in the analysis step.

### Effect of Invention

According to the present invention, it is possible to provide a work analysis device, a work analysis system, a work analysis method, and a recording medium that are capable of efficiently searching for an optimal procedure to perform a plurality of work items.

### BRIEF DESCRIPTION OF THE DRAWINGS

FIG. 1 is a diagram showing an example of a work analysis system 1 according to a first example embodiment.

FIG. 2 is a diagram showing an example of trajectories of the execution positions at which users of the VR device 11 perform a plurality of work items in a virtual space that has been generated by an analysis means 13D of a work analysis device 13.

FIG. 3 is a diagram for describing an example of extracting trajectories from the plurality of trajectories shown in FIG. 2 that satisfy a predetermined condition.

FIG. 4 is a diagram for describing an example of a second condition used for extracting trajectories from the plurality of trajectories shown in FIG. 2.

FIG. 5 is a diagram for describing an example of a result of analysis performed by the analysis means 13D of the work analysis device 13.

FIG. 6 is a diagram showing examples of correct execution orders indicated by information acquired by the acquisition means 13B of the work analysis device 13.

FIG. 7 is a diagram showing an example of determination results of whether or not the execution order of a plurality of work items performed by the users of the VR device 11 in the virtual space matches the correct execution order.

FIG. 8 is a diagram showing an example of a result of determining, for each execution position, whether or not the execution order of a plurality of work items performed by the users of the VR device 11 in the virtual space matches the correct execution order.

FIG. 9 is a diagram showing an example of utilizing a tendency in the execution order of a plurality of work items performed by the users of the VR device 11 in the virtual space, and an adherence rate to the correct execution order.

FIG. 10 is a diagram showing an example of a state in which a visualized concentration level of a skill-possessing user of the VR device 11 (model user) and a visualized concentration level of a non-skill-possessing user of the VR device 11 (other user) are compared.

FIG. 11 is a diagram showing an example of a state in which a visualized change in a time-series of the concentration level of a skill-possessing user of the VR device 11 (model user) and a visualized change in a time-series of the concentration level of a non-skill-possessing user of the VR device 11 (other user) are compared.

FIG. 12 is a diagram showing an example of a state in which a visualized stress level of a skill-possessing user of the VR device 11 (model user) and a visualized stress level of a non-skill-possessing user of the VR device 11 (other user) are compared.

FIG. 13 is a diagram showing an example of a state in which a visualized change in a time-series of the stress level of a skill-possessing user of the VR device 11 (model user) and a visualized change in a time-series of the stress level of a non-skill-possessing user of the VR device 11 (other user) are compared.

FIG. 14 is a diagram showing an example of a state in which a stress level of a skill-possessing user of the VR device 11 (model user) and an emotion of a non-skill-possessing user of the VR device 11 (other user) are compared.

FIG. 15 is a sequence diagram for describing an example of the processing performed in the work analysis system 1 according to the first example embodiment.

FIG. 16 is a diagram showing an example of a work analysis system 1 according to a fourth example embodiment.

FIG. 17 is a diagram showing an example of a work analysis system 1 according to a fifth example embodiment.

FIG. 18 is a diagram showing an example of a work analysis system 1 according to a sixth example embodiment.

FIG. 19 is a diagram showing an example of a work analysis device 13 according to a seventh example embodiment.

### EXAMPLE EMBODIMENT

Hereunder, example embodiments of a work analysis device, a work analysis system, a work analysis method, and a recording medium of the present invention will be described with reference to the drawings.

### First Example Embodiment

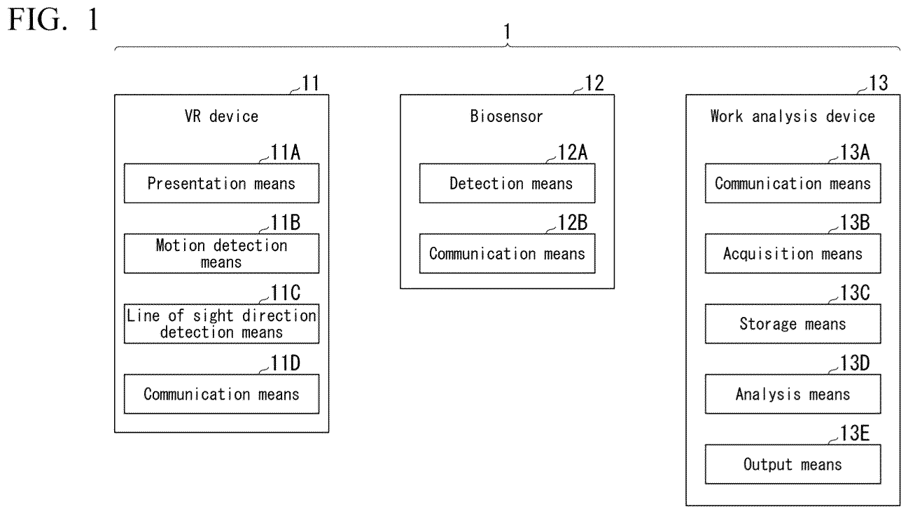

FIG. 1 is a diagram showing an example of a work analysis system 1 according to a first example embodiment.

In the example shown in FIG. 1, the work analysis system 1 is used, for example, in the training of an operator (more specifically, a user (wearer) of a VR device 11 described later) that performs a plurality of work items of a problem. The work analysis system 1 includes a VR device 11, a biosensor 12, and a work analysis device 13.

The VR device 11 is, for example, a head-mounted display device such as that described in Japanese Patent Publication No. 5464130. The VR device 11 includes a presentation means 11A, a motion detection means 11B, a line of sight direction detection means 11C, and a communication means 11D.

The presentation means 11A is a display such as a head-mounted display device. The presentation means 11A presents a plurality of work items of a problem that has been assigned to the user of the VR device 11 in a virtual space.

The motion detection means 11B is, for example, a controller of a head-mounted display device, or a remote controller (laser pointer). The motion detection means 11B detects motions made by the user of the VR device 11 to perform a plurality of work items in the virtual space. Specifically, the motion detection means 11B infers the motions made by the user of the VR device 11 to perform the plurality of work items in the virtual space based on input operations (such as an operation of pressing a button) made by the user of the VR device 11 with respect to, for example, the controller or the remote control (laser pointer). For example, in a case where the user of the VR device 11 presses a button of the controller, remote controller (laser pointer) or the like while pointing the controller, remote controller (laser pointer) or the like toward an execution position of a work item in the virtual space, the motion detection means 11B infers that the user of the VR device 11 has performed the work item.

The line of sight direction detection means 11C detects the line of sight direction of the user of the VR device 11. In the example shown in FIG. 1, the line of sight direction detection means 11C infers that the direction the user of VR device 11 is pointing using the controller, remote controller (laser pointer) or the like, is the line of sight direction of the user of the VR device 11.

In another example, in the manner of the technique described in the website at the URL below, by using an acceleration sensor (not shown) provided in the VR device 11, the line of sight direction detection means 11C may infer the orientation of the VR device 11 as being the line of sight direction of the user of the VR device 11.
https://www.watch.impress.co.jp/headline/docs/extra/vr/1060434.html

In yet other examples, the line of sight direction detection means 11C may detect the line of sight direction of the user of the VR device 11 by using an eye tracking technique such as that described in the websites at the URLs below.
https://www.tobiipro.com/ja/fields-of-use/vr-research/https://japan.cnet.com/article/35148863/https://www.vive.com/jp/product/vive-pro-eye/overview/

In the example shown in FIG. 1, the communication means 11D communicates with the work analysis device 13 and the like. The communication means 11D transmits, to the work analysis device 13, data representing motions that have been detected by the motion detection means 11B which are made by the user of the VR device 11 to perform the plurality of work items in the virtual space. Furthermore, the communication means 11D transmits, to the work analysis device 13, data indicating a line of sight direction of the user of the VR device 11 that has been detected by the line of sight direction detection means 11C.

The biosensor 12 is, for example, a wristband-type wearable device such as that described in Japanese Patent Publication No. 6911171 and the websites at the following URLs.
https://jpn.nec.com/embedded/products/emotion/index.html https://jpn.nec.com/manufacture/monozukuri/iot_mono/interview/13_emotion-analytics.html

The biosensor 12 includes, for example, a detection means 12A and a communication means 12B. The detection means 12A detects biometric information (such as a pulse rate or a pulse period) of the user of the VR device 11 (more specifically, the user of the VR device 11 that is wearing the biosensor 12). The communication means 12B communicates with the work analysis device 13 and the like. The communication means 12B transmits, to the work analysis device 13, biometric information of the user of the VR device 11 that has been detected by the detection means 12A.

The work analysis device 13 analyzes the plurality of work items that have been performed by the user of the VR device 11. In the work analysis system 1 according to the first example embodiment, the work analysis device 13 is placed in the cloud. However, in the work analysis system 1 according to the other example embodiments described below, the work analysis device 13 does not have to be placed in the cloud.

In the example shown in FIG. 1, the work analysis device 13 includes a communication means 13A, an acquisition means 13B, a storage means 13C, an analysis means 13D, and an output means 13E. The communication means 13A communicates with the VR device 11, the biosensor 12, and the like. For example, the communication means 13A receives the data transmitted by the communication means 11D of the VR device 11 representing the motions made by the user of the VR device 11 to perform the plurality of work items in the virtual space, and the data indicating the line of sight direction of the user of the VR device 11. Furthermore, the communication means 13A receives the biometric information of the user of the VR device 11 transmitted by the communication means 12B of the biosensor 12.

The acquisition means 13B acquires the data received by the communication means 13A representing the motions made by the user of the VR device 11 to perform the plurality of work items in the virtual space, the data indicating the line of sight direction of the user of the VR device 11, and the biometric information of the user of the VR device 11. That is to say, the acquisition means 13B acquires the data detected by the motion detection means 11B of the VR device 11 representing the motions made by the user of the VR device 11 to perform the plurality of work items in the virtual space, the data detected by the line of sight direction detection means 11C of the VR device 11 indicating the line of sight direction of the user of the VR device 11, and the biometric information of the user of the VR device 11 detected by the detection means 12A of the biosensor 12.

The storage means 13C generates and stores time-series data of the motions made by the user of the VR device 11 from the data (that is to say, instantaneous data) acquired by the acquisition means 13B representing the motions made by the user of the VR device 11 to perform the plurality of work items in the virtual space. Furthermore, the storage means 13C generates and stores time-series data of the line of sight direction of the user of the VR device 11 from the data (that is to say, instantaneous data) acquired by the acquisition means 13B indicating the line of sight direction of the user of the VR device 11. In addition, the storage means 13C generates and stores time-series data of the biometric information of the user of the VR device 11 from the biometric information (that is to say, instantaneous data) of the user of the VR device 11 acquired by the acquisition means 13B.

The analysis means 13D visualizes the changes in the motions made by the user of the VR device 11 to perform the plurality of work items in the virtual space based on the time-series data of the motions made by the user of the VR device 11 that is stored in the storage means 13C. For example, the analysis means 13D generates a trajectory of the execution positions of the plurality of work items performed by the user of the VR device 11 in the virtual space based on the time-series data of the motions made by the user of the VR device 11 that is stored in the storage means 13C. The output means 13E outputs an analysis result from the analysis means 13D (for example, a trajectory of the execution positions of the plurality of work items generated by the analysis means 13D).

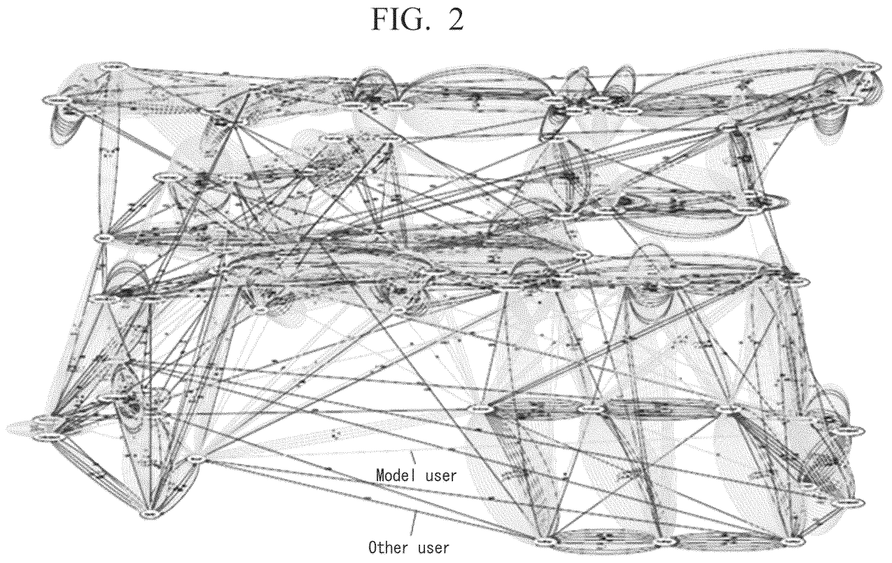

FIG. 2 is a diagram showing an example of trajectories of the execution positions at which users of the VR device 11 perform the plurality of work items in the virtual space that has been generated by the analysis means 13D of the work analysis device 13.

In the example shown in FIG. 2, the analysis means 13D generates trajectories of the execution positions at which the users of a plurality of VR devices 11 each performed the plurality of work items in the virtual space. That is to say, in FIG. 2, a plurality of trajectories corresponding to the users of a plurality of VR devices 11 is shown.

In order for the analysis means 13D of the work analysis device 13 to generate the plurality of trajectories as shown in FIG. 2, the first user of the VR device 11 firstly performs the plurality of work items in the virtual space, and the motion detection means 11B of the VR device 11 detects the motions made by the first user of the VR device 11 to perform the plurality of work items in the virtual space. The acquisition means 13B of the work analysis device 13 acquires data representing the motions that have been detected by the motion detection means 11B of the VR device 11 which are made by the first user of the VR device 11 to perform the plurality of work items in the virtual space. The storage means 13C of the work analysis device 13 generates and stores time-series data of the motions made by the first user of the VR device 11 from the data acquired by the acquisition means 13B representing the motions made by the first user of the VR device 11 to perform the plurality of work items in the virtual space. The analysis means 13D of the work analysis device 13 generates a trajectory of the execution positions of the plurality of work items performed by the first user of the VR device 11 in the virtual space based on the time-series data of the motions made by the first user of the VR device 11 that is stored in the storage means 13C.

After the first user of the VR device 11 performs the plurality of work items in the virtual space, second and subsequent users of the VR device 11 perform the plurality of work items in the virtual space, and the motion detection means 11B of the VR device 11 detects the motions made by the second and subsequent users of the VR device 11 to perform the plurality of work items in the virtual space. The acquisition means 13B of the work analysis device 13 acquires data representing the motions that have been detected by the motion detection means 11B of the VR device 11 which are made by the second and subsequent users of the VR device 11 to perform the plurality of work items in the virtual space. The storage means 13C of the work analysis device 13 generates and stores time-series data of the motions made by the second and subsequent users of the VR device 11 from the data acquired by the acquisition means 13B representing the motions made by the second and subsequent users of the VR device 11 to perform the plurality of work items in the virtual space. The analysis means 13D of the work analysis device 13 generates trajectories of the execution positions of the plurality of work items performed by the second and subsequent users of the VR device 11 in the virtual space based on the time-series data of the motions made by the second and subsequent users of the VR device 11 that is stored in the storage means 13C.

As a result, a plurality of trajectories are generated as shown in FIG. 2.

In the example shown in FIG. 2, the analysis means 13D of the work analysis device 13 compares the trajectory of the execution positions at which one user of the VR device 11 performed the plurality of work items in the virtual space (that is to say, one trajectory among the plurality of trajectories shown in FIG. 2) and the trajectories of the execution positions at which the other users of the VR device 11 performed the plurality of work items in the virtual space (that is to say, the other trajectories among the plurality of trajectories shown in FIG. 2).

As a result, in the example shown in FIG. 1 and FIG. 2, it is possible to efficiently search for the optimal procedure to perform the plurality of work items.

In order to more efficiently search for the optimal procedure to perform the plurality of work items, in the example of the work analysis system 1 according to the first example embodiment, a right-handed user of the VR device 11 firstly performs the plurality of work items in the virtual space, and the motion detection means 11B of the VR device 11 detects the motions made by the right-handed user of the VR device 11 to perform the plurality of work items in the virtual space. The acquisition means 13B of the work analysis device 13 acquires data representing the motions that have been detected by the motion detection means 11B of the VR device 11 which are made by the right-handed user of the VR device 11 to perform the plurality of work items in the virtual space. Furthermore, the acquisition means 13B acquires information indicating whether the user of the VR device 11 is right-handed or left-handed (in this example, information is acquired that indicates that the user of the VR device 11 is right-handed). The storage means 13C of the work analysis device 13 generates and stores time-series data of the motions made by the right-handed user of the VR device 11 from the data acquired by the acquisition means 13B representing the motions made by the right-handed user of the VR device 11 to perform the plurality of work items in the virtual space. The analysis means 13D of the work analysis device 13 generates a trajectory of the execution positions of the plurality of work items performed by the right-handed user of the VR device 11 in the virtual space based on the time-series data of the motions made by the right-handed user of the VR device 11 that is stored in the storage means 13C.

When a right-handed user of the VR device 11 has not performed the plurality of work items in the virtual space, a left-handed user of the VR device 11 performs the plurality of work items in the virtual space, and the motion detection means 11B of the VR device 11 detects the motions made by the left-handed user of the VR device 11 to perform the plurality of work items in the virtual space. The acquisition means 13B of the work analysis device 13 acquires data representing the motions that have been detected by the motion detection means 11B of the VR device 11 which are made by the left-handed user of the VR device 11 to perform the plurality of work items in the virtual space. Furthermore, the acquisition means 13B acquires information indicating whether the user of the VR device 11 is right-handed or left-handed (in this example, information is acquired that indicates that the user of the VR device 11 is left-handed). The storage means 13C of the work analysis device 13 generates and stores time-series data of the motions made by the left-handed user of the VR device 11 from the data acquired by the acquisition means 13B representing the motions made by the left-handed user of the VR device 11 to perform the plurality of work items in the virtual space. The analysis means 13D of the work analysis device 13 generates a trajectory of the execution positions of the plurality of work items performed by the left-handed user of the VR device 11 in the virtual space based on the time-series data of the motions made by the left-handed user of the VR device 11 that is stored in the storage means 13C.

The analysis means 13D of the work analysis device 13 compares the trajectory of the execution positions at which the right-handed user of the VR device 11 performed the plurality of work items in the virtual space, and the trajectory of the execution positions at which the left-handed user of the VR device 11 performed the plurality of work items in the virtual space.

Consequently, the analysis means 13D is able to grasp that the optimal procedure for a right-handed user of the VR device 11 to perform the plurality of items is different from the optimal procedure for a left-handed user of the VR device 11 to perform the plurality of work items (that is to say, that it is preferable for a work manual that differs between right-handed users and left-handed users to be prepared), and the like.

In order to more efficiently search for the optimal procedure to perform a plurality of work items, in another example of the work analysis system 1 according to the first example embodiment, a skill-possessing user (model user) of the VR device 11 firstly performs the plurality of work items in the virtual space, and the motion detection means 11B of the VR device 11 detects the motions made by the skill-possessing user of the VR device 11 to perform the plurality of work items in the virtual space. The acquisition means 13B of the work analysis device 13 acquires data representing the motions that have been detected by the motion detection means 11B of the VR device 11 which are made by the skill-possessing user of the VR device 11 to perform the plurality of work items in the virtual space. Furthermore, the acquisition means 13B acquires information indicating whether or not the user of the VR device 11 possesses a skill (in this example, information is acquired that indicates that the user of the VR device 11 possesses the skill). The storage means 13C of the work analysis device 13 generates and stores time-series data of the motions made by the skill-possessing user of the VR device 11 from the data acquired by the acquisition means 13B representing the motions made by the skill-possessing user of the VR device 11 to perform the plurality of work items in the virtual space. The analysis means 13D of the work analysis device 13 generates a trajectory of the execution positions of the plurality of work items performed by the skill-possessing user of the VR device 11 in the virtual space based on the time-series data of the motions made by the skill-possessing user of the VR device 11 that is stored in the storage means 13C.

When a skill-possessing user of the VR device 11 has not performed the plurality of work items in the virtual space, a non-skill-possessing user of the VR device 11 (another person) performs the plurality of work items in the virtual space, and the motion detection means 11B of the VR device 11 detects the motions made by the non-skill-possessing user of the VR device 11 to perform the plurality of work items in the virtual space. The acquisition means 13B of the work analysis device 13 acquires data representing the motions that have been detected by the motion detection means 11B of the VR device 11 which are made by the non-skill-possessing user of the VR device 11 to perform the plurality of work items in the virtual space. Furthermore, the acquisition means 13B acquires information indicating whether or not the user of the VR device 11 possesses the skill (in this example, information is acquired that indicates that the user of the VR device 11 does not possess the skill). The storage means 13C of the work analysis device 13 generates and stores time-series data of the motions made by the non-skill-possessing user of the VR device 11 from the data acquired by the acquisition means 13B representing the motions made by the non-skill-possessing user of the VR device 11 to perform the plurality of work items in the virtual space. The analysis means 13D of the work analysis device 13 generates a trajectory of the execution positions of the plurality of work items performed by the non-skill-possessing user of the VR device 11 in the virtual space based on the time-series data of the motions made by the non-skill-possessing user of the VR device 11 that is stored in the storage means 13C.

The analysis means 13D of the work analysis device 13 compares the trajectory of the execution positions at which the skill-possessing user of the VR device 11 performed the plurality of work items in the virtual space, and the trajectory of the execution positions at which the non-skill-possessing user of the VR device 11 performed the plurality of work items in the virtual space.

Consequently, by using the analysis results from the analysis means 13D, it is possible to grasp the aspects where guidance is needed for a person who does not possess the skill, and the like.

More specifically, in FIG. 2, the trajectories of the execution positions at which skill-possessing users of the VR device 11 performed the plurality of work items in the virtual space, and the trajectories of the execution positions at which non-skill-possessing users of the VR device 11 performed the plurality of work items in the virtual space are shown using different line types.

As shown in FIG. 2, as a result of the analysis means 13D of the work analysis device 13 performing the analysis, for example, it is possible to grasp that the trajectories of the execution positions at which the skill-possessing users of the VR device 11 performed the plurality of work items in the virtual space (the trajectories labeled as “model user” in FIG. 2) differ significantly from the trajectories of the execution positions at which the non-skill-possessing users of the VR device 11 performed the plurality of work items in the virtual space (the trajectories labeled as “other user” in FIG. 2), and the like.

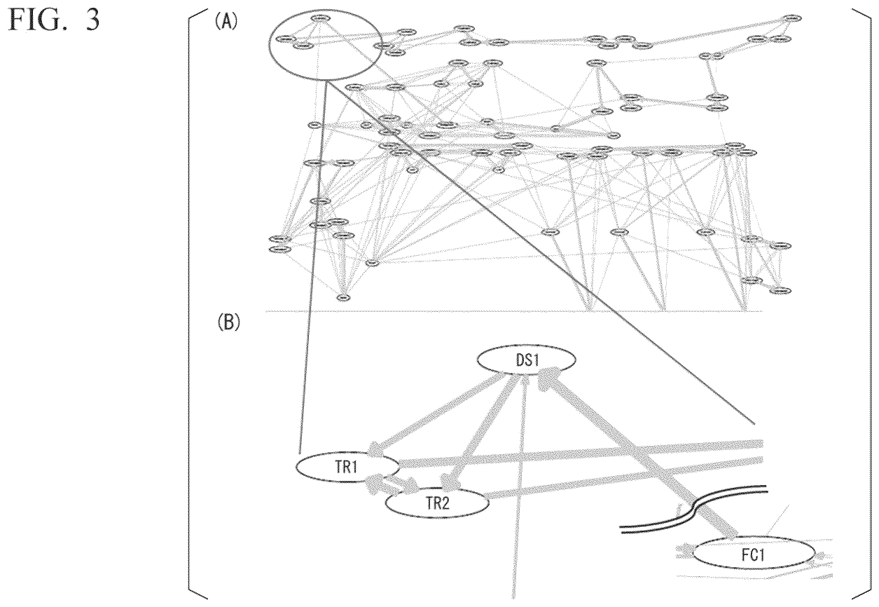

FIG. 3 is a diagram for describing an example of extracting trajectories from the plurality of trajectories shown in FIG. 2 that satisfy a predetermined condition. Specifically, FIG. 3(A) shows a state where trajectories that satisfy a first condition described below, being the trajectories of the execution positions at which each of the plurality of skill-possessing users of the VR device 11 performed the plurality of work items in the virtual space, have been extracted from the plurality of trajectories shown in FIG. 2 (that is to say, from the trajectories of the execution positions at which each of the skill-possessing users of the VR device 11 performed the plurality of work items in the virtual space, and the trajectories of the execution positions at which each of the non-skill-possessing users of the VR device 11 performed the plurality of work items in the virtual space). FIG. 3(B) shows enlarged a portion of FIG. 3(A).

In the example shown in FIG. 3, as in the example shown in FIG. 2, the analysis means 13D of the work analysis device 13 generates trajectories (the trajectories labeled as “model user” in FIG. 2) of the execution positions at which each of the plurality of skill-possessing users of the VR device 11 performed the plurality of work items in the virtual space. Furthermore, the analysis means 13D generates trajectories (the trajectories labeled as “other user” in FIG. 2) of the execution positions at which each of the plurality of non-skill-possessing users of the VR device 11 performed the plurality of work items in the virtual space. In addition, the analysis means 13D extracts the trajectories that satisfy a first condition from the trajectories of the plurality of skill-possessing users of the VR device 11 (the trajectories labeled as “model user” in FIG. 2), and visualizes the trajectories as shown in FIG. 3(A). The trajectories that satisfy the first condition include the trajectories in which the skill-possessing user of the VR device 11 firstly performed work item DS1, and the trajectories in which the skill-possessing user of the VR device 11 firstly performed work item FC1, and then secondly performed work item DS1.

That is to say, in the example shown in FIG. 3, in order for the analysis means 13D of the work analysis device 13 to extract the trajectories shown in FIG. 3(A) that satisfy the first condition, each of the plurality of skill-possessing users of the VR device 11 (model users) perform the plurality of work items in the virtual space, and the motion detection means 11B of the VR device 11 detects the motions made by each of the plurality of skill-possessing users of the VR device 11 to perform the plurality of work items in the virtual space. The acquisition means 13B of the work analysis device 13 acquires data representing the motions that have been detected by the motion detection means 11B of the VR device 11 which are made by each of the plurality of skill-possessing users of the VR device 11 to perform the plurality of work items in the virtual space. The storage means 13C of the work analysis device 13 generates and stores time-series data of the motions made by each of the plurality of skill-possessing users of the VR device 11 from the data acquired by the acquisition means 13B representing the motions made by each of the plurality of skill-possessing users of the VR device 11 to perform the plurality of work items in the virtual space.

The analysis means 13D of the work analysis device 13 generates a trajectory of the execution positions of the plurality of work items performed by each of the plurality of skill-possessing users of the VR device 11 in the virtual space based on the time-series data of the motions made by each of the plurality of skill-possessing users of the VR device 11 that is stored in the storage means 13C. In addition, the analysis means 13D extracts and visualizes, from the trajectories of the plurality of skill-possessing users of the VR device 11 (the trajectories labeled as “model user” in FIG. 2), the trajectories (the trajectories shown in FIG. 3(A) and FIG. 3(B)) that satisfy the first condition described above (more specifically, the trajectories of the execution positions of the plurality of work items performed by the skill-possessing users of the VR device 11 that firstly performed work item DS1, and the trajectories of execution positions of a plurality of work items performed by the skill-possessing users of the VR device 11 that firstly performed work item FC1 and then secondly performed work item DS1).

In the example shown in FIG. 3(B), a thicker line is displayed when a larger number of trajectories correspond to that trajectory.

In the example shown in FIG. 3, by using the analysis result from the analysis means 13D, it is possible to grasp the tendencies of the trajectories that satisfy the first condition described above.

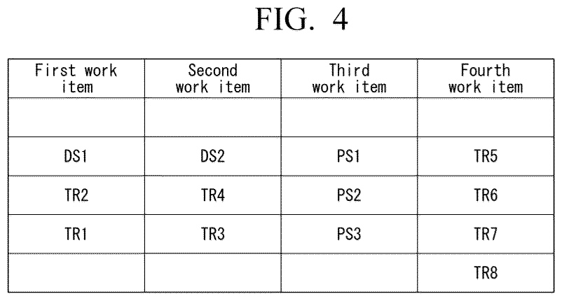

FIG. 4 is a diagram for describing an example of a second condition used for extracting trajectories from the plurality of trajectories shown in FIG. 2.

In the example shown in FIG. 4, as in the example shown in FIG. 2, the analysis means 13D of the work analysis device 13 generates trajectories (the trajectories labeled as “model user” in FIG. 2) of the execution positions at which each of the plurality of skill-possessing users of the VR device 11 performed the plurality of work items in the virtual space. Furthermore, the analysis means 13D generates trajectories (the trajectories labeled as “other user” in FIG. 2) of the execution positions at which each of the plurality of non-skill-possessing users of the VR device 11 performed the plurality of work items in the virtual space. In addition, the analysis means 13D extracts the trajectories that satisfy a second condition from the trajectories of the plurality of skill-possessing users of the VR device 11 (the trajectories labeled as “model user” in FIG. 2), and visualizes the trajectories in a tabular format as shown in FIG. 4. The trajectories that satisfy the second condition include trajectories in which a skill-possessing user of the VR device 11 firstly performed work item DS1, secondly performed work item DS2, thirdly performed work item PS1, and fourthly performed work item TR5, trajectories in which a skill-possessing user of the VR device 11 firstly performed work item TR2, secondly performed work item TR4, thirdly performed work item PS2, and fourthly performed work item TR6, and trajectories in which a skill-possessing user of the VR device 11 firstly performed work item TR1, secondly performed work item TR3, thirdly performed work item PS3, and fourthly performed work item TR7 or TR8.

That is to say, in the example shown in FIG. 4, in order for the analysis means 13D of the work analysis device 13 to extract the trajectories that satisfy the second condition, each of the plurality of skill-possessing users of the VR device 11 (model users) perform the plurality of work items in the virtual space, and the motion detection means 11B of the VR device 11 detects the motions made by each of the plurality of skill-possessing users of the VR device 11 to perform the plurality of work items in the virtual space. The acquisition means 13B of the work analysis device 13 acquires data representing the motions that have been detected by the motion detection means 11B of the VR device 11 which are made by each of the plurality of skill-possessing users of the VR device 11 to perform the plurality of work items in the virtual space. The storage means 13C of the work analysis device 13 generates and stores time-series data of the motions made by each of the plurality of skill-possessing users of the VR device 11 from the data acquired by the acquisition means 13B representing the motions made by each of the plurality of skill-possessing users of the VR device 11 to perform the plurality of work items in the virtual space.

The analysis means 13D of the work analysis device 13 generates a trajectory of the execution positions of the plurality of work items performed by each of the plurality of skill-possessing users of the VR device 11 in the virtual space based on the time-series data of the motions made by each of the plurality of skill-possessing users of the VR device 11 that is stored in the storage means 13C. In addition, the analysis means 13D extracts, from among the trajectories of the plurality of skill-possessing users of the VR device 11 (the trajectories labeled as “model user” in FIG. 2), the trajectories that satisfy the second condition described above having the same tendencies in the execution order of the work items (more specifically, the trajectories in which a skill-possessing user of the VR device 11 firstly performed work item DS1, secondly performed work item DS2, thirdly performed work item PS1, and fourthly performed work item TR5; trajectories in which a skill-possessing user of the VR device 11 firstly performed work item TR2, secondly performed work item TR4, thirdly performed work item PS2, and fourthly performed work item TR6; and trajectories in which a skill-possessing user of the VR device 11 firstly performed work item TR1, secondly performed work item TR3, thirdly performed work item PS3, and fourthly performed work item TR7 or TR8), and groups and assembles the trajectories into tabular data as shown in FIG. 4.

In the example shown in FIG. 4, by using the analysis result from the analysis means 13D, it is possible to assemble the trajectories that satisfy the second condition having the same tendencies in the execution order of the work items.

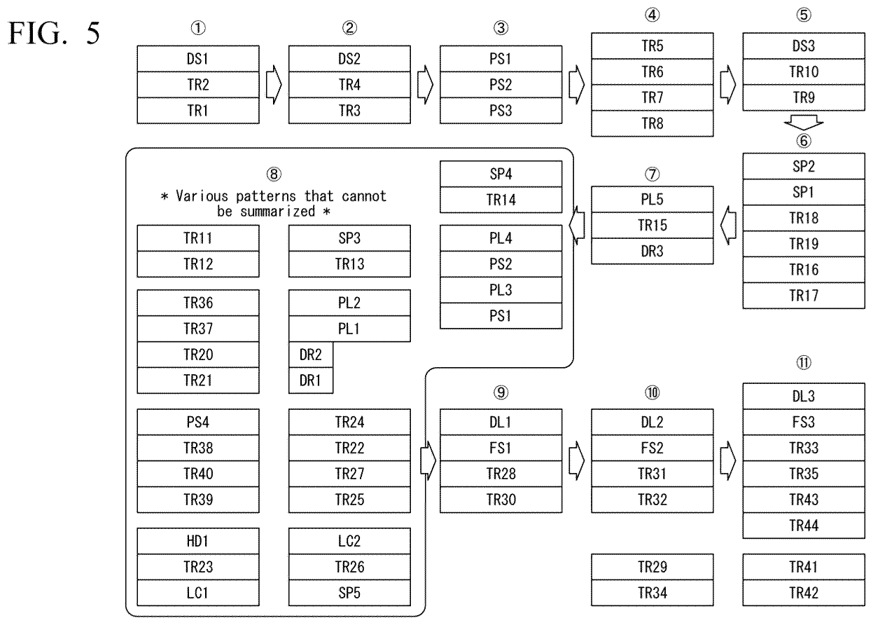

FIG. 5 is a diagram for describing an example of a result of analysis performed by the analysis means 13D of the work analysis device 13.

In the example shown in FIG. 5, the first skill-possessing user (first model user) of the VR device 11 firstly performs the plurality of work items in the virtual space, and the motion detection means 11B of the VR device 11 detects the motions made by the first skill-possessing user of the VR device 11 to perform the plurality of work items in the virtual space. The acquisition means 13B of the work analysis device 13 acquires data representing the motions that have been detected by the motion detection means 11B of the VR device 11 which are made by the skill-possessing first user of the VR device 11 to perform the plurality of work items in the virtual space. Furthermore, the acquisition means 13B acquires information indicating whether or not the first user of the VR device 11 possesses the skill (in this example, information is acquired that indicates that the first user of the VR device 11 possesses the skill). The storage means 13C of the work analysis device 13 generates and stores time-series data of the motions made by the skill-possessing first user of the VR device 11 from the data acquired by the acquisition means 13B representing the motions made by the skill-possessing first user of the VR device 11 to perform the plurality of work items in the virtual space. The analysis means 13D of the work analysis device 13 generates a trajectory of the execution positions of the plurality of work items performed by the skill-possessing first user of the VR device 11 in the virtual space based on the time-series data of the motions made by the skill-possessing first user of the VR device 11 that is stored in the storage means 13C.

When the first skill-possessing user of the VR device 11 has not performed the plurality of work items in the virtual space, second and subsequent skill-possessing users of the VR device 11 (second and subsequent model users) perform the plurality of work items in the virtual space, and the motion detection means 11B of the VR device 11 detects the motions made by the second and subsequent skill-possessing users of the VR device 11 to perform the plurality of work items in the virtual space. The acquisition means 13B of the work analysis device 13 acquires data representing the motions that have been detected by the motion detection means 11B of the VR device 11 which are made by the second and subsequent skill-possessing users of the VR device 11 to perform the plurality of work items in the virtual space. Furthermore, the acquisition means 13B acquires information indicating whether or not the second and subsequent users of the VR device 11 possess the skill (in this example, information is acquired that indicates that the second and subsequent users of the VR device 11 possess the skill). The storage means 13C of the work analysis device 13 generates and stores time-series data of the motions made by the second and subsequent skill-possessing users of the VR device 11 from the data acquired by the acquisition means 13B representing the motions made by the second and subsequent skill-possessing users of the VR device 11 to perform the plurality of work items in the virtual space. The analysis means 13D of the work analysis device 13 generates a trajectory of the execution positions of the plurality of work items performed by the skill-possessing second and subsequent users of the VR device 11 in the virtual space based on the time-series data of the motions made by the skill-possessing second and subsequent users of the VR device 11 that is stored in the storage means 13C.

In the example shown in FIG. 5, the analysis means 13D analyzes that the plurality of skill-possessing users of the VR device 11 (the first user and the second and subsequent users) performed work item DS1, work item TR2, and work item TR1 as first work items (first work item group). Furthermore, the analysis means 13D analyzes that the plurality of skill-possessing users of the VR device 11 performed work item DS2, work item TR4, and work item TR3 as second work items (second work item group). In addition, the analysis means 13D analyzes that the plurality of skill-possessing users of the VR device 11 performed work item PS1, work item PS2, and work item PS3 as third work items (third work item group).

The analysis means 13D analyzes that the plurality of skill-possessing users of the VR device 11 performed work item TR5, work item TR6, work item TR7, and work item TR8 as fourth work items (fourth work item group). Furthermore, the analysis means 13D analyzes that a plurality of skill-possessing users of the VR device 11 performed work item DS3, work item TR10, and work item TR9 as fifth work items (fifth work item group). In addition, the analysis means 13D analyzes that the plurality of skill-possessing users of the VR device 11 performed work item SP2, work item SP1, work item TR18, work item TR19, work item TR16, and work item TR17 as sixth work items (sixth work item group).

The analysis means 13D analyzes that the plurality of skill-possessing users of the VR device 11 performed work item PL5, work item TR15, and work item DR3 as seventh work items (seventh work item group). Furthermore, the analysis means 13D analyzes that the plurality of skill-possessing users of the VR device 11 performed at least one of multiple work items, such as work item SP4, work item TR14, work item PL4, work item PS2, work item PL3, and work item PS1 as eighth work items (eighth work item group).

The analysis means 13D analyzes that the plurality of skill-possessing users of the VR device 11 performed work item DL1, work item FS1, work item TR28, and work item TR30 as ninth work items (ninth work item group). In addition, the analysis means 13D analyzes that the plurality of skill-possessing users of the VR device 11 performed work item DL2, work item FS2, work item TR31, and work item TR32 as tenth work items (tenth work item group). Also, the analysis means 13D analyzes that the plurality of skill-possessing users of the VR device 11 performed work item DL3, work item FS3, work item TR33, work item TR35, work item TR43, work item TR44, work item TR41, work item TR42, work item TR29, and work item TR34 as eleventh work items (eleventh work item group).

Specifically, in the example shown in FIG. 5, the analysis means 13D extracts, from among the trajectories of the plurality of skill-possessing users of the VR device 11 (the first and second and subsequent users), the execution position of work item DS1 as the execution position of the first work item in a predetermined proportion (such as 50%) or more of the trajectories, and extracts the execution position of any one of work item TR41, work item TR42, work item TR43, and work item TR44 as the execution position of the last work item in a predetermined proportion (such as 50%) or more of the trajectories.

In the example shown in FIG. 5, the acquisition means 13B of the work analysis device 13 does not acquire information indicating whether a user of the VR device 11 are right-handed or left-handed. However, in another example, the acquisition means 13B of the work analysis device 13 may acquire information indicating whether a user of the VR device 11 is right-handed or left-handed.

In this example, each of the plurality of skill-possessing right-handed users of the VR device 11 perform the plurality of work items in the virtual space, and the motion detection means 11B of the VR device 11 detects the motions made by each of the plurality of skill-possessing right-handed users of the VR device 11 to perform the plurality of work items in the virtual space. The acquisition means 13B of the work analysis device 13 acquires data representing the motions that have been detected by the motion detection means 11B of the VR device 11 which are made by each of the plurality of skill-possessing right-handed users of the VR device 11 to perform the plurality of work items in the virtual space. Furthermore, the acquisition means 13B acquires information indicating whether or not each of the plurality of skill-possessing users of the VR device 11 is right-handed (in this example, information is acquired that indicates that each of the plurality of skill-possessing users of the VR device 11 is right-handed). The storage means 13C of the work analysis device 13 generates and stores time-series data of the motions made by each of the plurality of skill-possessing right-handed users of the VR device 11 from the data acquired by the acquisition means 13B representing the motions made by each of the plurality of skill-possessing right-handed users of the VR device 11 to perform the plurality of work items in the virtual space. The analysis means 13D of the work analysis device 13 generates a trajectory of the execution positions of the plurality of work items performed by each of the plurality of skill-possessing right-handed users of the VR device 11 in the virtual space based on the time-series data of the motions made by each of the plurality of skill-possessing right-handed users of the VR device 11 that is stored in the storage means 13C. In addition, the analysis means 13 extracts, from the trajectories of the plurality of skill-possessing right-handed users of the VR device 11, the execution position of the first work item and the execution position of the last work item in a predetermined proportion (such as 50%) or more of the trajectories.

Furthermore, in this example, each of the plurality of skill-possessing left-handed users of the VR device 11 perform the plurality of work items in the virtual space, and the motion detection means 11B of the VR device 11 detects the motions made by each of the plurality of skill-possessing left-handed users of the VR device 11 to perform the plurality of work items in the virtual space. The acquisition means 13B of the work analysis device 13 acquires data representing the motions that have been detected by the motion detection means 11B of the VR device 11 which are made by each of the plurality of skill-possessing left-handed users of the VR device 11 to perform the plurality of work items in the virtual space. Moreover, the acquisition means 13B acquires information indicating whether or not each of the plurality of skill-possessing users of the VR device 11 is left-handed (in this example, information is acquired that indicates that each of the plurality of skill-possessing users of the VR device 11 is left-handed). The storage means 13C of the work analysis device 13 generates and stores time-series data of the motions made by each of the plurality of skill-possessing left-handed users of the VR device 11 from the data acquired by the acquisition means 13B representing the motions made by each of the plurality of skill-possessing left-handed users of the VR device 11 to perform the plurality of work items in the virtual space. The analysis means 13D of the work analysis device 13 generates a trajectory of the execution positions of the plurality of work items performed by each of the plurality of skill-possessing left-handed users of the VR device 11 in the virtual space based on the time-series data of the motions made by each of the plurality of skill-possessing left-handed users of the VR device 11 that is stored in the storage means 13C. In addition, the analysis means 13 extracts, from the trajectories of the plurality of skill-possessing left-handed users of the VR device 11, the execution position of the first work item and the execution position of the last work item in a predetermined proportion (such as 50%) or more of the trajectories.

That is to say, in this example, it is possible to distinguish and efficiently search the optimal procedure for a skill-possessing right-handed user of the VR device 11, and the optimal procedure for a skill-possessing left-handed user of the VR device 11.

In the example shown in FIG. 5, the acquisition means 13B of the work analysis device 13 does not acquire information indicating a correct execution order, being an execution order that is correct for a plurality of work items of a problem that has been specified in advance. However, in another example, the acquisition means 13B of the work analysis device 13 may acquire information indicating the correct execution order.

In this example, the storage means 13C of the work analysis device 13 stores information indicating the correct execution order that has been acquired by the acquisition means 13B. The analysis means 13D of the work analysis device 13 determines whether or not the execution order of the plurality of work items performed by the user of the VR device 11 in the virtual space matches the correct execution order.

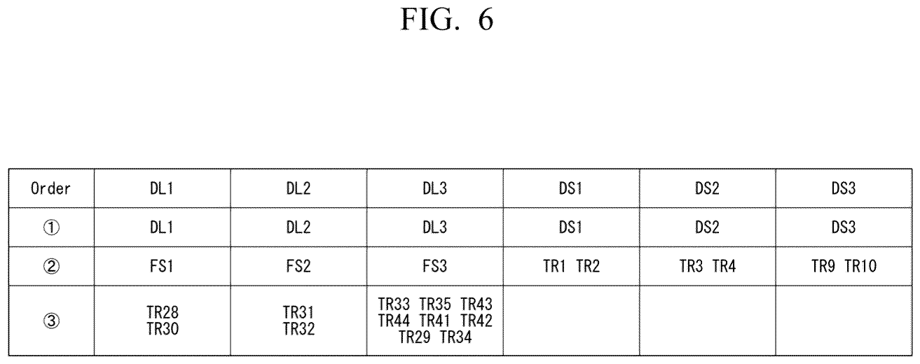

FIG. 6 is a diagram showing an example of correct execution orders indicated by information acquired by the acquisition means 13B of the work analysis device 13.

In the example shown farthest to the left in FIG. 6, the correct execution order of the four work items included in the ninth work item group shown in FIG. 5, (work item DL1, work item FS1, work item TR28, and work item TR30), is set in an order of work item DL1→work item FS1→work item TR28 or work item TR30.

In the example shown second from the left in FIG. 6, the correct execution order of the four work items included in the tenth work item group shown in FIG. 5, (work item DL2, work item FS2, work item TR31, and work item TR32), is set in an order of work item DL2→work item FS2→work item TR31 or work item TR32.

In the example shown third from the left in FIG. 6, the correct execution order of the ten work items included in the eleventh work item group shown in FIG. 5, (work item DL3, work item FS3, work item TR33, work item TR35, work item TR43, work item TR44, work item TR41, work item TR42, work item TR29, and work item TR34), is set in an order of work item DL3→work item FS3→any one of work item TR33, work item TR35, work item TR43, work item TR44, work item TR41, work item TR42, work item TR29, or work item TR34.

In the example shown third from the right in FIG. 6, the correct execution order of the three work items included in the first work item group shown in FIG. 5, (work item DS1, work item TR2, and work item TR1), is set in an order of work item DS1→work item TR1 or work item TR2.

In the example shown second from the right in FIG. 6, the correct execution order of the three work items included in the second work item group shown in FIG. 5, (work item DS2, work item TR4, and work item TR3), is set in an order of work item DS2-+work item TR3 or work item TR4.

In the example shown farthest to the right in FIG. 6, the correct execution order of the three work items included in the fifth work item group shown in FIG. 5, (work item DS3, work item TR10, and work item TR9), is set in an order of work item DS3→work item TR9 or work item TR10.

In the example shown in FIG. 6, the acquisition means 13B of the work analysis device 13 acquires information indicating, from among the plurality of work items of a problem (the plurality of work items included in the first to eleventh work item groups shown in FIG. 5), the correct execution order of work items including work item D1 and subsequent thereto (an order of work item DL1→work item FS1→work item TR28 or work item TR30), information indicating the correct execution order of work items including work item D2 and subsequent thereto (an order of work item DL2→work item FS2→work item TR31 or work item TR32), information indicating the correct execution order of work items including work item DL3 and subsequent thereto (an order of work item DL3→work item FS3→any one of work item TR33, work item TR35, work item TR43, work item TR44, work item TR41, work item TR42, work item TR29, or work item TR34), information indicating the correct execution order of work items including work item DS1 and subsequent thereto (an order of work item DS1→work item TR1 or work item TR2), information indicating the correct execution order of work items including work item DS2 and subsequent thereto (an order of DS2→work item TR3 or work item TR4), and information indicating the correct execution order of work items including work item DS3 and subsequent thereto (an order of work item DS3→work item TR9 or work item TR10).

The storage means 13C of the work analysis device 13 stores information indicating the correct execution order (an order of work item DL1→work item FS1-+work item TR28 or work item TR30), information indicating the correct execution order (an order of work item DL2→work item FS2→work item TR31 or work item TR32), information indicating the correct execution order (an order of work item DL3→work item FS3→any one of work item TR33, work item TR35, work item TR43, work item TR44, work item TR41, work item TR42, work item TR29, or work item TR34), information indicating the correct execution order (an order of work item DS1→work item TR1 or work item TR2), information indicating the correct execution order (an order of DS2→work item TR3 or work item TR4), and information indicating the correct execution order (an order of work item DS3→work item TR9 or work item TR10) that has been acquired by the acquisition means 13B.

The analysis means 13D of the work analysis device 13 determines whether or not the execution order of the plurality of work items including work item DL1 and subsequent thereto performed by the user of the VR device 11 in the virtual space matches the correct execution order (an order of work item DL1→work item FS1→work item TR28 or work item TR30). Furthermore, the analysis means 13D determines whether or not the execution order of the plurality of work items including work item DL2 and subsequent thereto performed by the user of the VR device 11 in the virtual space matches the correct execution order (an order of work item DL2→work item FS2→work item TR31 or work item TR32). In addition, the analysis means 13D determines whether or not the execution order of the plurality of work items including work item DL3 and subsequent thereto performed by the user of the VR device 11 in the virtual space matches the correct execution order (an order of work item DL3→work item FS3→any one of work item TR33, work item TR35, work item TR43, work item TR44, work item TR41, work item TR42, work item TR29, or work item TR34).

The analysis means 13D determines whether or not the execution order of the plurality of work items including work item DS1 and subsequent thereto performed by the user of the VR device 11 in the virtual space matches the correct execution order (an order of work item DS1→work item TR1 or work item TR2). Furthermore, the analysis means 13D determines whether or not the execution order of the plurality of work items including work item DS2 and subsequent thereto performed by the user of the VR device 11 in the virtual space matches the correct execution order (an order of work item DS2-+work item TR3 or work item TR4). In addition, the analysis means 13D determines whether or not the execution order of the plurality of work items including work item DS3 and subsequent thereto performed by the user of the VR device 11 in the virtual space matches the correct execution order (an order of work item DS3→work item TR9 or work item TR10).

That is to say, in the example shown in FIG. 6, by using the analysis result from the analysis means 13D, it is possible to grasp whether or not the correct execution order has been followed in each of the plurality of work item groups.

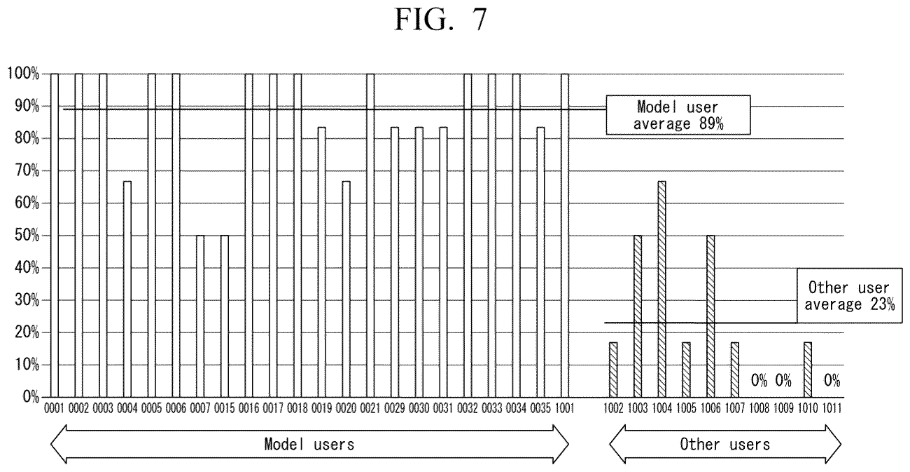

FIG. 7 is a diagram showing an example of determination results of whether or not the execution order of a plurality of work items performed by the users of the VR device 11 in the virtual space matches the correct execution order. Specifically, FIG. 7 shows determination results indicating whether or not the execution order of the plurality of work items performed by each of 22 skill-possessing users of the VR device 11 (labeled as “model users” in FIG. 7) in the virtual space matches the correct execution order, and determination results indicating whether or not the execution order of the plurality of work items performed by each of 10 non-skill-possessing users of the VR device 11 (labeled as “other users” in FIG. 7) in the virtual space matches the correct execution order.

In the example shown in FIG. 7, in order to obtain the determination results shown in FIG. 7, the acquisition means 13B of the work analysis device 13 acquires information indicating whether or not the user of the VR device 11 possess a skill, and acquires data representing the motions made by a skill-possessing user of the VR device 11 that has been detected by the VR device 11 to perform the plurality of work items in the virtual space. The storage means 13C of the work analysis device 13 generates and stores time-series data of the motions made by the skill-possessing user of the VR device 11 from the data acquired by the acquisition means 13B representing the motions made by the skill-possessing user of the VR device 11 to perform the plurality of work items in the virtual space. The analysis means 13D of the work analysis device 13 determines whether or not the execution order of the plurality of work items performed by the skill-possessing user of the VR device 11 in the virtual space matches the correct execution order.

As a result, in the example shown in FIG. 7, an adherence rate to the correct execution order is obtained for each of the 22 skill-possessing users of the VR device 11, which are indicated by ID “0001”, ID “0002”, ID “0003”, ID “0004”, ID “0005”, ID “0006”, ID “0007”, ID “0015”, ID “0016”, ID “0017”, ID “0018”, ID “0020”, ID “0021”, ID “0029”, ID “0030”, ID “0031”, ID “0032”, ID “0033”, ID “0034”, and ID “1001”. The average adherence rate to the correct execution order of the 22 skill-possessing users of the VR device 11 is 89%.

Furthermore, the acquisition means 13B of the work analysis device 13 acquires information indicating whether or not the user of the VR device 11 possesses the skill, and acquires data representing the motions made by a non-skill-possessing user of the VR device 11 that has been detected by the VR device 11 to perform the plurality of work items in the virtual space. The storage means 13C of the work analysis device 13 generates and stores time-series data of the motions made by the non-skill-possessing user of the VR device 11 from the data acquired by the acquisition means 13B representing the motions made by the non-skill-possessing user of the VR device 11 to perform the plurality of work items in the virtual space. The analysis means 13D of the work analysis device 13 determines whether or not the execution order of the plurality of work items performed by the non-skill-possessing user of the VR device 11 in the virtual space matches the correct execution order.

As a result, in the example shown in FIG. 7, an adherence rate to the correct execution order is obtained for each of the 10 non-skill-possessing users of the VR device 11, which are indicated by ID “1002”, ID “1003”, ID “1004”, ID “1005”, ID “1006”, ID “1007”, ID “1008”, ID “1009”, ID “1010”, and ID “1011”. The average adherence rate to the correct execution order of the 10 non-skill-possessing users of the VR device 11 is 23%.

The analysis means 13D compares the determination results indicating whether or not the execution order of the plurality of work items performed by the skill-possessing users of the VR device 11 in the virtual space matches the correct execution order, and the determination results indicating whether or not the execution order of the plurality of work items performed by the non-skill-possessing users of the VR device 11 in the virtual space matches the correct execution order.

The analysis means 13D generates a comparison result indicating that the average adherence rate to the correct execution order of the 22 skill-possessing users of the VR device 11 is 3.87 times the average adherence rate to the correct execution order of the 10 non-skill-possessing users of the VR device 11.

In the example shown in FIG. 7, the acquisition means 13B of the work analysis device 13 does not acquire information indicating whether a user of the VR device 11 is right-handed or left-handed. However, in another example, the acquisition means 13B of the work analysis device 13 may acquire information indicating whether a user of the VR device 11 is right-handed or left-handed.

In this example, the acquisition means 13B of the work analysis device 13 acquires information indicating whether the user of the VR device 11 is right-handed or left-handed, and acquires data representing the motions made by a right-handed user of the VR device 11 that has been detected by the VR device 11 to perform the plurality of work items in the virtual space. The storage means 13C of the work analysis device 13 generates and stores time-series data of the motions made by the right-handed user of the VR device 11 from the data acquired by the acquisition means 13B representing the motions made by the right-handed user of the VR device 11 to perform the plurality of work items in the virtual space. The analysis means 13D of the work analysis device 13 determines whether or not the execution order of the plurality of work items performed by the right-handed user of the VR device 11 in the virtual space matches the correct execution order.

Furthermore, the acquisition means 13B acquires information indicating whether the user of the VR device 11 is right-handed or left-handed, and acquires data representing the motions made by a left-handed user of the VR device 11 that has been detected by the VR device 11 to perform the plurality of work items in the virtual space. The storage means 13C generates and stores time-series data of the motions made by the left-handed user of the VR device 11 from the data acquired by the acquisition means 13B representing the motions made by the left-handed user of the VR device 11 to perform the plurality of work items in the virtual space. The analysis means 13D determines whether or not the execution order of the plurality of work items performed by the left-handed user of the VR device 11 in the virtual space matches the correct execution order.

Further, the analysis means 13D compares the determination results indicating whether or not the execution order of the plurality of work items performed by the right-handed users of the VR device 11 in the virtual space matches the correct execution order, and the determination results indicating whether or not the execution order of the plurality of work items performed by the left-handed users of the VR device 11 in the virtual space matches the correct execution order.

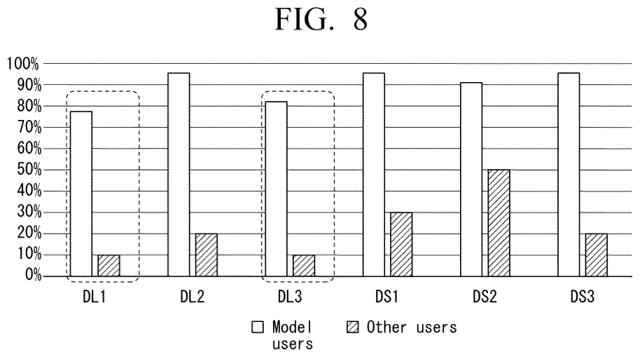

FIG. 8 is a diagram showing an example of a result of determining, for each execution position, whether or not the execution order of a plurality of work items performed by the users of the VR device 11 in the virtual space matches the correct execution order. Specifically, FIG. 8 shows a comparison of the result of determining, for each execution position of a work item, whether or not the execution order of the plurality of work items performed by the skill-possessing users of the VR device 11 in the virtual space matches the correct execution order, and the result of determining, for each execution position of a work item, whether or not the execution order of the plurality of work items performed by the non-skill-possessing users of the VR device 11 in the virtual space matches the correct execution order.

In the example shown farthest to the left in FIG. 8, the analysis means 13D of the work analysis device 13 determines whether or not the execution order of the plurality of work items including work item DL1 and subsequent thereto performed by the plurality of skill-possessing users of the VR device 11 (labeled as “model users” in FIG. 8) in the virtual space matches the correct execution order (an order of work item DL1→work item FS1-work item TR28 or work item TR30), and obtains a determination result indicating that, for approximately 78% of the skill-possessing users of the VR device 11, the execution order of the plurality of work items including work item DL1 and subsequent thereto performed in the virtual space matches the correct execution order. Furthermore, the analysis means 13D determines whether or not the execution order of the plurality of work items including work DL1 item and subsequent thereto performed by the plurality of non-skill-possessing users of the VR device 11 (labeled as “other users” in FIG. 8) in the virtual space matches the correct execution order, and obtains a determination result indicating that, for approximately 10% of the non-skill-possessing users of the VR device 11, the execution order of the plurality of work items including work item DL1 and subsequent thereto performed in the virtual space matches the correct execution order.

In the example shown second from the left in FIG. 8, the analysis means 13D determines whether or not the execution order of the plurality of work items including work item DL2 and subsequent thereto performed by the plurality of skill-possessing users of the VR device 11 in the virtual space matches the correct execution order (an order of work item DL2→work item FS2→work item TR31 or work item TR32), and obtains a determination result indicating that, for approximately 96% of the skill-possessing users of the VR device 11, the execution order of the plurality of work items including work item DL2 and subsequent thereto performed in the virtual space matches the correct execution order. Moreover, the analysis means 13D determines whether or not the execution order of the plurality of work items including work item DL2 and subsequent thereto performed by the plurality of non-skill-possessing users of the VR device 11 in the virtual space matches the correct execution order, and obtains a determination result indicating that, for approximately 20% of the non-skill-possessing users of the VR device 11, the execution order of the plurality of work items including work item DL2 and subsequent thereto performed in the virtual space matches the correct execution order.

In the example shown third from the left in FIG. 8, the analysis means 13D determines whether or not the execution order of the plurality of work items including work item DL3 and subsequent thereto performed by the plurality of skill-possessing users of the VR device 11 in the virtual space matches the correct execution order (an order of work item DL3→work item FS3→any one of work item TR33, work item TR35, work item TR43, work item TR44, work item TR41, work item TR42, work item TR29, or work item TR34), and obtains a determination result indicating that, for approximately 82% of the skill-possessing users of the VR device 11, the execution order of the plurality of work items including work item DL3 and subsequent thereto performed in the virtual space matches the correct execution order. Moreover, the analysis means 13D determines whether or not the execution order of the plurality of work items including work item DL3 and subsequent thereto performed by the plurality of non-skill-possessing users of the VR device 11 in the virtual space matches the correct execution order, and obtains a determination result indicating that, for approximately 10% of the non-skill-possessing users of the VR device 11, the execution order of the plurality of work items including work item DL2 and subsequent thereto performed in the virtual space matches the correct execution order.

In the example shown third from the right in FIG. 8, the analysis means 13D determines whether or not the execution order of the work items including work item DS1 and subsequent thereto performed by the plurality of skill-possessing users of the VR device 11 in the virtual space matches the correct execution order (an order of work item DS1→work item TR1 or work item TR2), and obtains a determination result indicating that, for approximately 96% of the skill-possessing users of the VR device 11, the execution order of the work items including work item DS1 and subsequent thereto performed in the virtual space matches the correct execution order. Moreover, the analysis means 13D determines whether or not the execution order of the work items including work item DS1 and subsequent thereto performed by the plurality of non-skill-possessing users of the VR device 11 in the virtual space matches the correct execution order, and obtains a determination result indicating that, for approximately 30% of the non-skill-possessing users of the VR device 11, the execution order of the work items including work item DS1 and subsequent thereto performed in the virtual space matches the correct execution order.

In the example shown second from the right in FIG. 8, the analysis means 13D determines whether or not the execution order of the work items including work item DS2 and subsequent thereto performed by the plurality of skill-possessing users of the VR device 11 in the virtual space matches the correct execution order (an order of work item DS2→work item TR3 or work item TR4), and obtains a determination result indicating that, for approximately 91% of the skill-possessing users of the VR device 11, the execution order of the work items including work item DS2 and subsequent thereto performed in the virtual space matches the correct execution order. Moreover, the analysis means 13D determines whether or not the execution order of the work items including work item DS2 and subsequent thereto performed by the plurality of non-skill-possessing users of the VR device 11 in the virtual space matches the correct execution order, and obtains a determination result indicating that, for approximately 50% of the non-skill-possessing users of the VR device 11, the execution order of the work items including work item DS2 and subsequent thereto performed in the virtual space matches the correct execution order.

In the example shown farthest to the right in FIG. 8, the analysis means 13D determines whether or not the execution order of the work items including work item DS3 and subsequent thereto performed by the plurality of skill-possessing users of the VR device 11 in the virtual space matches the correct execution order (an order of work item DS3→work item TR9 or work item TR10), and obtains a determination result indicating that, for approximately 96% of the skill-possessing users of the VR device 11, the execution order of the work items including work item DS3 and subsequent thereto performed in the virtual space matches the correct execution order. Moreover, the analysis means 13D determines whether or not the execution order of the work items including work item DS3 and subsequent thereto performed by the plurality of non-skill-possessing users of the VR device 11 in the virtual space matches the correct execution order, and obtains a determination result indicating that, for approximately 20% of the non-skill-possessing users of the VR device 11, the execution order of the work items including work item DS3 and subsequent thereto performed in the virtual space matches the correct execution order.

That is to say, in the example shown in FIG. 8, the analysis means 13D determines, for each execution position of a work item (that is to say, the execution position of the work items including work item DL1 and subsequent thereto, the execution position of the work items including work item DL2 and subsequent thereto, the execution position of the work items including work item DL3 and subsequent thereto, the execution position of the work items including work item DS1 and subsequent thereto, the execution position of the work items including work item DS2 and subsequent thereto, and the execution position of the work items including work item DS3 and subsequent thereto), whether or not the execution order of the plurality of work items performed by the users of the VR device 11 in the virtual space matches the correct execution order.

Specifically, in the example shown in FIG. 8 the acquisition means 13B acquires information indicating whether or not the user of the VR device 11 possess a skill, and acquires data representing the motions made by a skill-possessing user of the VR device 11 that has been detected by the VR device 11 to perform the plurality of work items in the virtual space. The storage means 13C generates and stores time-series data of the motions made by the skill-possessing user of the VR device 11 from the data acquired by the acquisition means 13B representing the motions made by the skill-possessing user of the VR device 11 to perform the plurality of work items in the virtual space. The analysis means determines, for each execution position of a work item, whether or not the execution order of the plurality of work items performed by the skill-possessing user of the VR device 11 in the virtual space matches the correct execution order.

Furthermore, the acquisition means 13B acquires information indicating whether or not the user of the VR device 11 possesses the skill, and acquires data representing the motions made by a non-skill-possessing user of the VR device 11 that has been detected by the VR device 11 to perform the plurality of work items in the virtual space. The storage means 13C generates and stores time-series data of the motions made by the non-skill-possessing user of the VR device 11 from the data acquired by the acquisition means 13B representing the motions made by the non-skill-possessing user of the VR device 11 to perform the plurality of work items in the virtual space. The analysis means 13D determines, for each execution position of a work item, whether or not the execution order of the plurality of work items performed by the non-skill-possessing user of the VR device 11 in the virtual space matches the correct execution order.

In addition, as shown in FIG. 8, the analysis means 13D compares, for each execution position of a work item, the determination results indicating whether or not the execution order of the plurality of work items performed by the skill-possessing users of the VR device 11 in the virtual space matches the correct execution order, and the determination results indicating whether or not the execution order of the plurality of work items performed by the non-skill-possessing users of the VR device 11 in the virtual space matches the correct execution order.

As a result, in the example shown in FIG. 8, the analysis means 13D obtains an analysis result indicating that, even in the case of the skill-possessing users of the VR device 11, the adherence rate to the correct execution order is low for the execution position of the work items including work item DL1 and subsequent thereto, and for the execution position of the work items including work item DL3 and subsequent thereto.

In the example shown in FIG. 8, the acquisition means 13B of the work analysis device 13 does not acquire information indicating whether a user of the VR device 11 is right-handed or left-handed. However, in another example, the acquisition means 13B of the work analysis device 13 may acquire information indicating whether a user of the VR device 11 is right-handed or left-handed.

In this example, the acquisition means 13B of the work analysis device 13 acquires information indicating whether the user of the VR device 11 is right-handed or left-handed, and acquires data representing the motions made by a right-handed user of the VR device 11 that has been detected by the VR device 11 to perform the plurality of work items in the virtual space. The storage means 13C generates and stores time-series data of the motions made by the right-handed user of the VR device 11 from the data acquired by the acquisition means 13B representing the motions made by the right-handed user of the VR device 11 to perform the plurality of work items in the virtual space. The analysis means 13D determines, for each execution position of a work item, whether or not the execution order of the plurality of work items performed by the right-handed user of the VR device 11 in the virtual space matches the correct execution order. Furthermore, the acquisition means 13B acquires information indicating whether the user of the VR device 11 is right-handed or left-handed, and acquires data representing the motions made by a left-handed user of the VR device 11 that has been detected by the VR device 11 to perform the plurality of work items in the virtual space. The storage means 13C generates and stores time-series data of the motions made by the left-handed user of the VR device 11 from the data acquired by the acquisition means 13B representing the motions made by the left-handed user of the VR device 11 to perform the plurality of work items in the virtual space. The analysis means 13D determines, for each execution position of a work item, whether or not the execution order of the plurality of work items performed by the left-handed user of the VR device 11 in the virtual space matches the correct execution order.

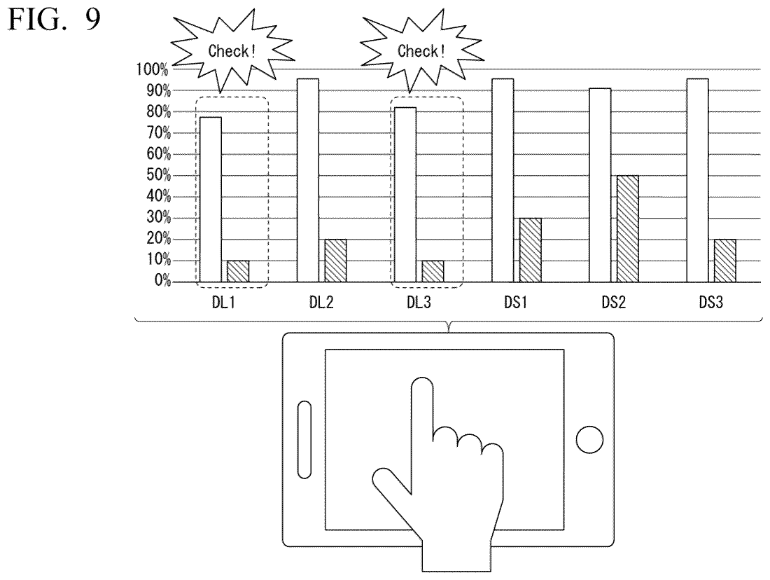

FIG. 9 is a diagram showing an example of utilizing a tendency in the execution order of a plurality of work items performed by the users of the VR device 11 in the virtual space, and an adherence rate to the correct execution order.

In the example shown in FIG. 9, the analysis means 13D of the work analysis device 13 determines whether or not the execution order of the plurality of work items performed by each of the plurality of users of the VR device 11 in the virtual space matches the correct execution order.

Specifically, as in the example shown in FIG. 8, the analysis means 13D determines whether or not the execution order of the plurality of work items performed by the users of the VR device 11 in the virtual space matches the correct execution order (an order of work item DL1→work item FS1→work item TR28 or work item TR30), determines whether or not the execution order of the plurality of work items performed by the users of the VR device 11 in the virtual space matches the correct execution order (an order of work item DL2→work item FS2→work item TR31 or work item TR32), and determines whether or not the execution order of the plurality of work items performed by the users of the VR device 11 in the virtual space matches the correct execution order (an order of work item DL3→work item FS3→any one of work item TR33, work item TR35, work item TR43, work item TR44, work item TR41, work item TR42, work item TR29, or work item TR34).

Furthermore, as in the example shown in FIG. 8, the analysis means 13D determines whether or not the execution order of the plurality of work items performed by the users of the VR device 11 in the virtual space matches the correct execution order (an order of work item DS1→work item TR1 or work item TR2), determines whether or not the execution order of the plurality of work items performed by the users of the VR device 11 in the virtual space matches the correct execution order (an order of work item DS2→work item TR3 or work item TR4), and determines whether or not the execution order of the plurality of work items performed by the users of the VR device 11 in the virtual space matches the correct execution order (an order of work item DS3→work item TR9 or work item TR10).

In addition, the analysis means 13D extracts, from among the plurality of work items of a problem, work items in which a probability of each of the plurality of users of the VR device 11 performing an execution order that is different from the correct execution order is higher than a predetermined threshold (that is, work items in which the adherence rate to the execution order is low).

Specifically, in the example shown in FIG. 9, the analysis means 13D extracts, from among the plurality of work items of the problem shown in FIG. 5, the work items including work item DL1 and subsequent thereto (indicated by “Check!” in FIG. 9) and the work items including work item DL3 and subsequent thereto (indicated by “Check!” in FIG. 9) as work items in which the probability of the skill-possessing users of the VR device 11 performing an execution order that is different from the correct execution order is higher than a predetermined threshold (such as 10%) (that is to say, work items in which the adherence rate to the execution order is, for example, less than 90%).

As a result of presenting the correct execution order of work items including work item DL1 and subsequent thereto, the correct execution order of work items including work item DL2 and subsequent thereto, the correct execution order of work items including work item DL3 and subsequent thereto, the correct execution order of work items including work item DS1 and subsequent thereto, the correct execution order of work items including work item DS2 and subsequent thereto, and the correct execution order of work items including work item DS3 and subsequent thereto to an untrained user (for example, a non-skill-possessing user of the VR device 11), an improvement in the skill of the untrained user can be expected. Furthermore, by clearly indicating in a work manual the work items in which the adherence rate to the execution order is low as areas requiring special attention, an improvement in the adherence rate to the execution order can be expected.

In the example shown in FIG. 9, the acquisition means 13B of the work analysis device 13 does not acquire information indicating whether a user of the VR device 11 is right-handed or left-handed. However, in another example, the acquisition means 13B of the work analysis device 13 may acquire information indicating whether a user of the VR device 11 is right-handed or left-handed.

In this example, the acquisition means 13B of the work analysis device 13 acquires information indicating whether the user of the VR device 11 is right-handed or left-handed, and acquires data representing the motions made by a right-handed user of the VR device 11 that has been detected by the VR device 11 to perform the plurality of work items in the virtual space. The storage means 13C of the work analysis device 13 generates and stores time-series data of the motions made by the right-handed user of the VR device 11 from the data acquired by the acquisition means 13B representing the motions made by the right-handed user of the VR device 11 to perform the plurality of work items in the virtual space. The analysis means 13D of the work analysis device 13 determines whether or not the execution order of the plurality of work items performed by each of the plurality of right-handed users of the VR device 11 in the virtual space matches the correct execution order. In addition, the analysis means 13D extracts, from among the plurality of work items of a problem, work items in which a probability of each of the plurality of right-handed users of the VR device 11 performing an execution order that is different from the correct execution order is higher than a predetermined threshold (that is, work items in which the adherence rate to the execution order is low).

Furthermore, the acquisition means 13B acquires information indicating whether the user of the VR device 11 is right-handed or left-handed, and acquires data representing the motions made by a left-handed user of the VR device 11 that has been detected by the VR device 11 to perform the plurality of work items in the virtual space. The storage means 13C generates and stores time-series data of the motions made by the left-handed user of the VR device 11 from the data acquired by the acquisition means 13B representing the motions made by the left-handed user of the VR device 11 to perform the plurality of work items in the virtual space. The analysis means 13D determines whether or not the execution order of the plurality of work items performed by each of the plurality of left-handed users of the VR device 11 in the virtual space matches the correct execution order. In addition, the analysis means 13D extracts, from among the plurality of work items of a problem, work items in which a probability of each of the plurality of left-handed users of the VR device 11 performing an execution order that is different from the correct execution order is higher than a predetermined threshold (that is, work items in which the adherence rate to the execution order is low).

In this example, by comparing the work items in which the adherence rate to the execution order of right-handed users of the VR device 11 is low, and the work items in which the adherence rate to the execution order of left-handed users of the VR device 11 is low, for example, it is possible to propose a work manual for right-handed users of the VR device 11 that is different from the work manual for left-handed users of the VR device 11, and the like.

Furthermore, in the example shown in FIG. 1, the analysis means 13D of the work analysis device 13 visualizes a change in the line of sight direction of the user of the VR device 11 based on the time-series data of the line of sight direction of the user of the VR device 11 that is stored in the storage means 13C. For example, the analysis means 13D generates a trajectory of the line of sight direction of the user of the VR device 11 based on the time-series data of the line of sight direction of the user of the VR device 11 that is stored in the storage means 13C. The output means 13E outputs an analysis result from the analysis means 13D (for example, a trajectory of the line of sight direction of the user of the VR device 11 generated by the analysis means 13D).

The analysis means 13D generates, as in the example shown in FIG. 2, trajectories of the line of sight direction of each of the plurality of users of the VR device 11.

In order for the analysis means 13D to generate the trajectories of the line of sight direction of each of the plurality of users of the VR device 11 as in the example shown in FIG. 2, the first user of the VR device 11 firstly performs a plurality of work items in the virtual space, and the line of sight direction detection means 11C of the VR device 11 detects the line of sight direction of the first user of the VR device 11. The acquisition means 13B acquires data indicating the line of sight direction of the first user of the VR device 11 that has been detected by the line of sight direction detection means 11C of the VR device 11. The storage means 13C generates and stores time-series data of the line of sight direction of the first user of the VR device 11 from the data acquired by the acquisition means 13B indicating the line of sight direction of the first user of the VR device 11. The analysis means 13D generates a trajectory of the line of sight direction of the first user of the VR device 11 based on the time-series data of the line of sight direction of the first user of the VR device 11 that is stored in the storage means 13C.

After the first user of the VR device 11 performs the plurality of work items in the virtual space, the second and subsequent users of the VR device 11 perform the plurality of work items in the virtual space, and the line of sight direction detection means 11C of the VR device 11 detects the line of sight direction of the second and subsequent users of the VR device 11. The acquisition means 13B acquires data indicating the line of sight direction of the second and subsequent users of the VR device 11 that has been detected by the line of sight direction detection means 11C of the VR device 11. The storage means 13C generates and stores time-series data of the line of sight direction of the second and subsequent users of the VR device 11 from the data acquired by the acquisition means 13B indicating the line of sight direction of the second and subsequent users of the VR device 11. The analysis means 13D generates a trajectory of the line of sight direction of the second and subsequent users of the VR device 11 based on the time-series data of the line of sight direction of the second and subsequent users of the VR device 2 that is stored in the storage means 13C.

As a result, as in the plurality of trajectories of the execution positions of the plurality of work items shown in FIG. 2, trajectories of the line of sight direction of the plurality of users of the VR device 11 are generated.

The analysis means 13D compares the trajectory of the line of sight direction of one user of the VR device 11 and the trajectories of the line of sight direction of the other users of the VR device 11.

Consequently, in the example shown in FIG. 1, it is possible to efficiently search for the optimal procedure to perform a plurality of work items by analyzing the trajectories of the line of sight direction of the plurality of users of the VR device 11.

In the example shown in FIG. 1, by using the trajectory of the line of sight direction of the one user of the VR device 11, the analysis means 13D analyzes the presence of an execution position of a work item that has been overlooked by the user of the VR device 11 and the like.

Specifically, the acquisition means 13B acquires information representing the plurality of work items of a problem that the user of the VR device 11 needs to perform in the virtual space. The information representing the plurality of work items of a problem that the user of the VR device 11 needs to perform in the virtual space is, for example, data representing the plurality of work items of a problem that are presented by VR device 11 in the virtual space using the presentation means 11A. The analysis means 13D extracts, from among the plurality of work items of a problem indicated by the information that has been acquired by the acquisition means 13B, the work items that the user of the VR device 11 has not performed in the virtual space (that is to say, work items of a problem for which the line of sight direction of the user of the VR device 11 did not face the execution position) as work items that have been overlooked by the user of the VR device 11.

As a result, in the example shown in FIG. 1, feedback about the work items that have been overlooked by the user of the VR device 11 can be provided to the user of the VR device 11 and the like.

In order to more efficiently search for the optimal procedure to perform the plurality of work items, in the example of the work analysis system 1 according to the first example embodiment, a right-handed user of the VR device 11 firstly performs the plurality of work items in the virtual space, and the line of sight direction detection means 11C of the VR device 11 detects the line of sight direction of the right-handed user of the VR device 11. The acquisition means 13B of the work analysis device 13 acquires information indicating whether the user of the VR device 11 is right-handed or left-handed (in this example, information is acquired that indicates that the user of the VR device 11 is right-handed). Furthermore, the acquisition means 13B acquires data indicating the line of sight direction of the right-handed user of the VR device 11 that has been detected by the line of sight direction detection means 11C of the VR device 11. The analysis means 13D of the work analysis device 13 extracts, from among the plurality of work items of a problem indicated by the information that has been acquired by the acquisition means 13B, the work items that the right-handed user of the VR device 11 has not performed in the virtual space as work items that have been overlooked by the right-handed user of the VR device 11.

When a right-handed user of the VR device 11 has not performed the plurality of work items in the virtual space, a left-handed user of the VR device 11 performs the plurality of work items in the virtual space, and the line of sight direction detection means 11C of the VR device 11 detects the line of sight direction of the left-handed user of the VR device 11. The acquisition means 13B of the work analysis device 13 acquires information indicating whether the user of the VR device 11 is right-handed or left-handed (in this example, information is acquired that indicates that the user of the VR device 11 is left-handed). Furthermore, the acquisition means 13B acquires data indicating the line of sight direction of the left-handed user of the VR device 11 that has been detected by the line of sight direction detection means 11C of the VR device 11. The analysis means 13D of the work analysis device 13 extracts, from among the plurality of work items of a problem indicated by the information that has been acquired by the acquisition means 13B, the work items that the left-handed user of the VR device 11 has not performed in the virtual space as work items that have been overlooked by the left-handed user of the VR device 11.

The analysis means 13D of the work analysis device 13 compares the work items that have been overlooked by the right-handed users of the VR device 11, and the work items that have been overlooked by the left-handed users of the VR device 11.

Consequently, the analysis means 13D is capable of distinguishing and grasping the work items that tend to be overlooked by the right-handed users of the VR device 11, and the work items that tend to be overlooked by the left-handed users of the VR device 11.

In addition, in the example shown in FIG. 1, the analysis means 13 extracts, based on the time-series data of the motions of the user of the VR device 11 and the time-series data of the line of sight direction of the user of the VR device 11 that are stored in the storage means 13C, the timings in which the line of sight direction of the user of the VR device 11 is not facing the execution position of the work items performed by the user of the VR device 11 in the virtual space. That is to say, the analysis means 13D extracts work items that the user of the VR device 11 did not overlook, but were performed while the user of the VR device 11 was looking elsewhere.

As a result, feedback about the work items performed while looking elsewhere that have been extracted by the analysis means 13D can be provided to the user of the VR device 11 and the like.

In order to more efficiently search for the optimal procedure to perform the plurality of work items, in the example of the work analysis system 1 according to the first example embodiment, a right-handed user of the VR device 11 firstly performs the plurality of work items in the virtual space, the motion detection means 11B of the VR device 11 detects the motions made by the right-handed user of the VR device 11 to perform the plurality of work items in the virtual space, and the line of sight direction detection means 11C of the VR device 11 detects the line of sight direction of the right-handed user of the VR device 11. The acquisition means 13B of the work analysis device 13 acquires information indicating whether the user of the VR device 11 is right-handed or left-handed (in this example, information is acquired that indicates that the user of the VR device 11 is right-handed). Furthermore, the acquisition means 13B acquires the data detected by the motion detection means 11B of the VR device 11 representing the motions made by the right-handed user of the VR device 11 to perform the plurality of work items in the virtual space, and the data detected by the line of sight direction detection means 11C of the VR device 11 indicating the line of sight direction of the right-handed user of the VR device 11.

The storage means 13C of the work analysis device 13 generates and stores time-series data of the motions made by the right-handed user of the VR device 11 from the data acquired by the acquisition means 13B representing the motions made by the right-handed user of the VR device 11 to perform the plurality of work items in the virtual space. In addition, the storage means 13C generates and stores time-series data of the line of sight direction of the right-handed user of the VR device 11 from the data acquired by the acquisition means 13B indicating the line of sight direction of the right-handed user of the VR device 11.

The analysis means 13 of the work analysis device 13 extracts, based on the time-series data of the motions of the right-handed user of the VR device 11 and the time-series data of the line of sight direction of the right-handed user of the VR device 11 that are stored in the storage means 13C, the timings in which the line of sight direction of the right-handed user of the VR device 11 is not facing the execution position of the work items performed by the right-handed user of the VR device 11 in the virtual space.

When a right-handed user of the VR device 11 has not performed the plurality of work items in the virtual space, a left-handed user of the VR device 11 performs the plurality of work items in the virtual space, the motion detection means 11B of the VR device 11 detects the motions made by the left-handed user of the VR device 11 to perform the plurality of work items in the virtual space, and the line of sight direction detection means 11C of the VR device 11 detects the line of sight direction of the left-handed user of the VR device 11. The acquisition means 13B of the work analysis device 13 acquires information indicating whether the user of the VR device 11 is right-handed or left-handed (in this example, information is acquired that indicates that the user of the VR device 11 is left-handed). Furthermore, the acquisition means 13B acquires the data detected by the motion detection means 11B of the VR device 11 representing the motions made by the left-handed user of the VR device 11 to perform the plurality of work items in the virtual space, and the data detected by the line of sight direction detection means 11C of the VR device 11 indicating the line of sight direction of the left-handed user of the VR device 11.

The storage means 13C of the work analysis device 13 generates and stores time-series data of the motions made by the left-handed user of the VR device 11 from the data acquired by the acquisition means 13B representing the motions made by the left-handed user of the VR device 11 to perform the plurality of work items in the virtual space. In addition, the storage means 13C generates and stores time-series data of the line of sight direction of the left-handed user of the VR device 11 from the data acquired by the acquisition means 13B indicating the line of sight direction of the left-handed user of the VR device 11.

The analysis means 13 of the work analysis device 13 extracts, based on the time-series data of the motions of the left-handed user of the VR device 11 and the time-series data of the line of sight direction of the left-handed user of the VR device 11 that are stored in the storage means 13C, the timings in which the line of sight direction of the left-handed user of the VR device 11 is not facing the execution position of the work items performed by the left-handed user of the VR device 11 in the virtual space.

As a result, feedback about the tendencies of right-handed users and the tendencies of left-handed users that have been extracted by the analysis means 13D can be provided to the user of the VR device 11 and the like.

In order to more efficiently search for the optimal procedure to perform a plurality of work items, in another example of the work analysis system 1 according to the first example embodiment, a skill-possessing user of the VR device 11 firstly performs the plurality of work items in the virtual space, and the motion detection means 11B of the VR device 11 detects the motions made by the skill-possessing user of the VR device 11 to perform the plurality of work items in the virtual space. The acquisition means 13B of the work analysis device 13 acquires data representing the motions that have been detected by the motion detection means 11B of the VR device 11 which are made by the skill-possessing user of the VR device 11 to perform the plurality of work items in the virtual space. Furthermore, the acquisition means 13B acquires information indicating whether or not the user of the VR device 11 possesses a skill (in this example, information is acquired that indicates that the user of the VR device 11 possesses the skill). The storage means 13C of the work analysis device 13 generates and stores time-series data of the motions made by the skill-possessing user of the VR device 11 from the data acquired by the acquisition means 13B representing the motions made by the skill-possessing user of the VR device 11 to perform the plurality of work items in the virtual space.

When a skill-possessing user of the VR device 11 has not performed the plurality of work items in the virtual space, a non-skill-possessing user of the VR device 11 performs the plurality of work items in the virtual space, and the motion detection means 11B of the VR device 11 detects the motions made by the non-skill-possessing user of the VR device 11 to perform the plurality of work items in the virtual space. The acquisition means 13B of the work analysis device 13 acquires data representing the motions that have been detected by the motion detection means 11B of the VR device 11 which are made by the non-skill-possessing user of the VR device 11 to perform the plurality of work items in the virtual space. Furthermore, the acquisition means 13B acquires information indicating whether or not the user of the VR device 11 possesses the skill (in this example, information is acquired that indicates that the user of the VR device 11 does not possess the skill). The storage means 13C of the work analysis device 13 generates and stores time-series data of the motions made by the non-skill-possessing user of the VR device 11 from the data acquired by the acquisition means 13B representing the motions made by the non-skill-possessing user of the VR device 11 to perform the plurality of work items in the virtual space.

The analysis means 13D of the work analysis device 13 compares the time-series data of the motions made by the skill-possessing users of the VR device 11 that is stored in the storage means 13C, and the time-series data of the motions made by the non-skill-possessing users of the VR device 11 that is stored in the storage means 13C.

As a result, feedback about the tendencies for each skill that are obtained from the analysis result (that is to say, the comparison result of the motions made by the skill-possessing users of the VR device 11 and the motions made by the non-skill-possessing users of the VR device 11) from the analysis means 13D can be provided to the user of the VR device 11 and the like.

In order to more efficiently search for the optimal procedure to perform the plurality of work items, in another example of the work analysis system 1 according to the first example embodiment, a skill-possessing user of the VR device 11 firstly performs the plurality of work items in the virtual space, and the line of sight direction detection means 11C of the VR device 11 detects the line of sight direction of the skill-possessing user of the VR device 11. The acquisition means 13B of the work analysis device 13 acquires data indicating the line of sight direction of the skill-possessing user of the VR device 11 that has been detected by the line of sight direction detection means 11C of the VR device 11. Furthermore, the acquisition means 13B acquires information indicating whether or not the user of the VR device 11 possesses a skill (in this example, information is acquired that indicates that the user of the VR device 11 possesses the skill). The storage means 13C of the work analysis device 13 generates and stores time-series data of the line of sight direction of the skill-possessing user of the VR device 11 from the data acquired by the acquisition means 13B indicating the line of sight direction of the skill-possessing user of the VR device 11.

When a skill-possessing user of the VR device 11 has not performed the plurality of work items in the virtual space, a non-skill-possessing user of the VR device 11 performs the plurality of work items in the virtual space, and the line of sight direction detection means 11C of the VR device 11 detects the line of sight direction of the non-skill-possessing user of the VR device 11. The acquisition means 13B of the work analysis device 13 acquires data indicating the line of sight direction of the non-skill-possessing user of the VR device 11 that has been detected by the line of sight direction detection means 11C of the VR device 11. Furthermore, the acquisition means 13B acquires information indicating whether or not the user of the VR device 11 possesses the skill (in this example, information is acquired that indicates that the user of the VR device 11 does not possess the skill). The storage means 13C of the work analysis device 13 generates and stores time-series data of the line of sight direction of the non-skill-possessing user of the VR device 11 from the data acquired by the acquisition means 13B indicating the line of sight direction of the non-skill-possessing user of the VR device 11.

The analysis means 13D of the work analysis device 13 compares the time-series data of the line of sight direction of the skill-possessing users of the VR device 11 that is stored in the storage means 13C, and the time-series data of the line of sight direction of the non-skill-possessing users of the VR device 11 that is stored in the storage means 13C.

As a result, feedback about the tendencies for each skill that are obtained from the analysis result (that is to say, the comparison result of the line of sight direction of the skill-possessing users of the VR device 11 and the line of sight direction of the non-skill-possessing users of the VR device 11) from the analysis means 13D can be provided to the user of the VR device 11 and the like.

That is to say, in this example, the areas where there is a large statistical difference between the time-series data of the line of sight direction of users of the VR device 11 whose work results do not satisfy a standard (for example, the non-skill-possessing users of the VR device 11), and the time-series data of the line of sight direction of users of the VR device 11 whose work results satisfy the standard (for example, the non-skill-possessing users of the VR device 11) are extracted and output.

In order to more efficiently search for the optimal procedure to perform the plurality of work items, in another example of the work analysis system 1 according to the first example embodiment, a skill-possessing user of the VR device 11 firstly performs the plurality of work items in the virtual space, and the detection means 12A of the biosensor 12 detects biometric information of the skill-possessing user of the VR device 11. The acquisition means 13B of the work analysis device 13 acquires biometric information of the skill-possessing user of the VR device 11 that has been detected by the detection means 12A of the biosensor 12. Furthermore, the acquisition means 13B acquires information indicating whether or not the user of the VR device 11 possesses a skill (in this example, information is acquired that indicates that the user of the VR device 11 possesses the skill). The storage means 13C of the work analysis device 13 generates and stores time-series data of the biometric information of the skill-possessing user of the VR device 11 from the biometric information of the skill-possessing user of the VR device 11 that has been acquired by the acquisition means 13B.

When a skill-possessing user of the VR device 11 has not performed the plurality of work items in the virtual space, a non-skill-possessing user of the VR device 11 performs the plurality of work items in the virtual space, and the detection means 12A of the biosensor 12 detects biometric information of the non-skill-possessing user of the VR device 11. The acquisition means 13B of the work analysis device 13 acquires biometric information of the non-skill-possessing user of the VR device 11 that has been detected by the detection means 12A of the biosensor 12. Furthermore, the acquisition means 13B acquires information indicating whether or not the user of the VR device 11 possesses the skill (in this example, information is acquired that indicates that the user of the VR device 11 does not possess the skill). The storage means 13C of the work analysis device 13 generates and stores time-series data of the biometric information of the non-skill-possessing user of the VR device 11 from the biometric information of the non-skill-possessing user of the VR device 11 that has been acquired by the acquisition means 13B.

The analysis means 13D of the work analysis device 13 compares the time-series data of the biometric information of the skill-possessing users of the VR device 11 that is stored in the storage means 13C, and the time-series data of the biometric information of the non-skill-possessing users of the VR device 11 that is stored in the storage means 13C.

As a result, feedback about the tendencies for each skill that are obtained from the analysis result (that is to say, the comparison result of the biometric information of the skill-possessing users of the VR device 11 and the biometric information of the non-skill-possessing users of the VR device 11) from the analysis means 13D can be provided to the user of the VR device 11 and the like.

As a result of using the technique described in the websites and the like at the URLs below, the analysis means 13D estimates the concentration level of the user of the VR device 11 from the biometric information of the user of the VR device 11 that has been detected by the detection means 12A of the biosensor 12.
https://jpn.nec.com/embedded/products/emotion/case.html
https://www.necmp.co.jp/advanced_services/achievement/kickoff.html

Furthermore, the analysis means 13D visualizes the concentration level of the user of the VR device 11 in the manner of the technique described in the websites and the like at the URLs above.

In order to more efficiently search for the optimal procedure to perform the plurality of work items, in the example of the work analysis system 1 according to the first example embodiment, a skill-possessing user of the VR device 11 firstly performs the plurality of work items in the virtual space, and the detection means 12A of the biosensor 12 detects biometric information of the skill-possessing user of the VR device 11. The acquisition means 13B of the work analysis device 13 acquires biometric information of the skill-possessing user of the VR device 11 that has been detected by the detection means 12A of the biosensor 12. Furthermore, the acquisition means 13B acquires information indicating whether or not the user of the VR device 11 possesses a skill (in this example, information is acquired that indicates that the user of the VR device 11 possesses the skill). The analysis means 13D of the work analysis device 13 estimates and visualizes the concentration level of the skill-possessing user of the VR device 11 from the biometric information of the skill-possessing user of the VR device 11 that has been acquired by the acquisition means 13B.

When a skill-possessing user of the VR device 11 has not performed the plurality of work items in the virtual space, a non-skill-possessing user of the VR device 11 performs the plurality of work items in the virtual space, and the detection means 12A of the biosensor 12 detects biometric information of the non-skill-possessing user of the VR device 11. The acquisition means 13B of the work analysis device 13 acquires biometric information of the non-skill-possessing user of the VR device 11 that has been detected by the detection means 12A of the biosensor 12. Furthermore, the acquisition means 13B acquires information indicating whether or not the user of the VR device 11 possesses the skill (in this example, information is acquired that indicates that the user of the VR device 11 does not possess the skill). The analysis means 13D of the work analysis device 13 estimates and visualizes the concentration level of the non-skill-possessing user of the VR device 11 from the biometric information of the non-skill-possessing user of the VR device 11 that has been acquired by the acquisition means 13B.

The analysis means 13D of the work analysis device 13 compares the visualized concentration level of the skill-possessing users of the VR device 11, and the visualized concentration level of the non-skill-possessing users of the VR device 11.

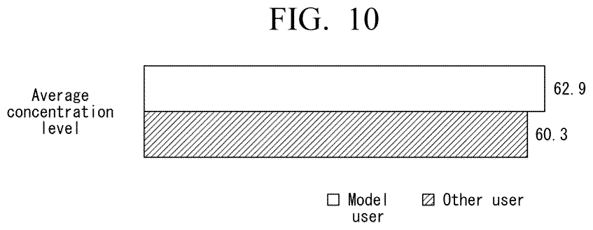

FIG. 10 is a diagram showing an example of a state in which a visualized concentration level of a skill-possessing user of the VR device 11 (model user) and a visualized concentration level of a non-skill-possessing user of the VR device 11 (other user) are compared.

In the example shown in FIG. 10, the analysis means 13D of the work analysis device 13 visualizes that the average concentration level of the skill-possessing user of the VR device 11 (labeled as “model user” in FIG. 10) during the period in which the skill-possessing user of the VR device 11 is performing the plurality of work items shown in FIG. 5 in the virtual space is 62.9%. Furthermore, the analysis means 13D visualizes that the average concentration level of the non-skill-possessing user of the VR device 11 (labeled as “other user” in FIG. 10) during the period in which the non-skill-possessing user of the VR device 11 is performing the plurality of work items shown in FIG. 5 in the virtual space is 60.3%.

In the example shown in FIG. 1, the user of the VR device 11 performs a plurality of work items in a virtual space, and the detection means 12A of the biosensor 12 detects the biometric information of the user of the VR device 11. The acquisition means 13B of the work analysis device 13 acquires biometric information of the user of the VR device 11 that has been detected by the detection means 12A of the biosensor 12. The storage means 13C of the work analysis device 13 generates and stores time-series data of the biometric information of the user of the VR device 11 from the biometric information of the user of the VR device 11 that has been acquired by the acquisition means 13B. The analysis means 13D of the work analysis device 13 estimates and analyzes a change in the time-series of the concentration level of the user of the VR device 11 from the time-series data of the biometric information of the user of the VR device 11 that is stored in the storage means 13C.

In order to more efficiently search for the optimal procedure to perform the plurality of work items, in the example of the work analysis system 1 according to the first example embodiment, a skill-possessing user of the VR device 11 firstly performs the plurality of work items in the virtual space, and the detection means 12A of the biosensor 12 detects biometric information of the skill-possessing user of the VR device 11. The acquisition means 13B of the work analysis device 13 acquires biometric information of the skill-possessing user of the VR device 11 that has been detected by the detection means 12A of the biosensor 12. Furthermore, the acquisition means 13B acquires information indicating whether or not the user of the VR device 11 possesses a skill (in this example, information is acquired that indicates that the user of the VR device 11 possesses the skill). The storage means 13C of the work analysis device 13 generates and stores time-series data of the biometric information of the skill-possessing user of the VR device 11 from the biometric information of the skill-possessing user of the VR device 11 that has been acquired by the acquisition means 13B. The analysis means 13D of the work analysis device 13 estimates and visualizes a change in the time-series of the concentration level of the skill-possessing user of the VR device 11 from the time-series data of the biometric information of the skill-possessing user of the VR device 11 that is stored in the storage means 13C.

When a skill-possessing user of the VR device 11 has not performed the plurality of work items in the virtual space, a non-skill-possessing user of the VR device 11 performs the plurality of work items in the virtual space, and the detection means 12A of the biosensor 12 detects biometric information of the non-skill-possessing user of the VR device 11. The acquisition means 13B of the work analysis device 13 acquires biometric information of the non-skill-possessing user of the VR device 11 that has been detected by the detection means 12A of the biosensor 12. Furthermore, the acquisition means 13B acquires information indicating whether or not the user of the VR device 11 possesses the skill (in this example, information is acquired that indicates that the user of the VR device 11 does not possess the skill). The storage means 13C of the work analysis device 13 generates and stores time-series data of the biometric information of the non-skill-possessing user of the VR device 11 from the biometric information of the non-skill-possessing user of the VR device 11 that has been acquired by the acquisition means 13B. The analysis means 13D of the work analysis device 13 estimates and visualizes a change in the time-series of the concentration level of the non-skill-possessing user of the VR device 11 from the time-series data of the biometric information of the non-skill-possessing user of the VR device 11 that is stored in the storage means 13C.

In addition, the analysis means 13D compares the visualized change in the time-series of the concentration level of the skill-possessing users of the VR device 11, and the visualized change in the time-series of the concentration level of the non-skill-possessing users of the VR device 11.

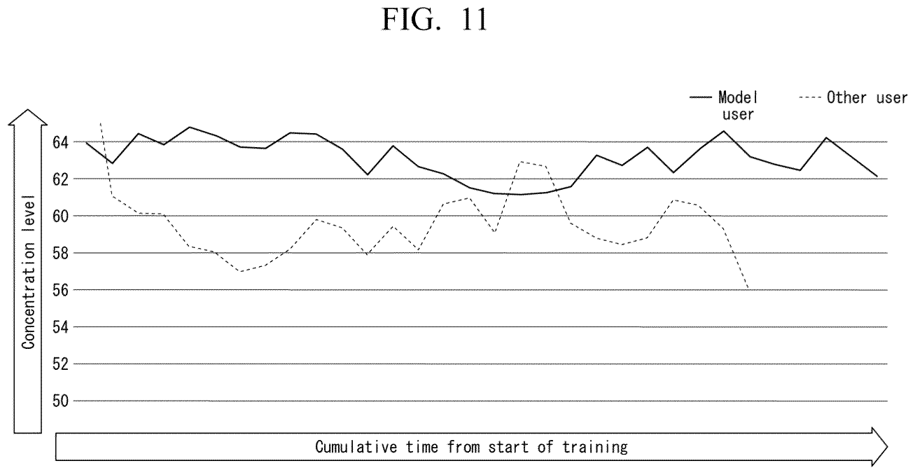

FIG. 11 is a diagram showing an example of a state in which a visualized change in a time-series of the concentration level of a skill-possessing user of the VR device 11 (model user) and a visualized change in a time-series of the concentration level of a non-skill-possessing user of the VR device 11 (other user) are compared. In FIG. 11, the vertical axis represents the concentration level of the skill-possessing user of the VR device 11 and the non-skill-possessing user of the VR device 11, and the horizontal axis represents the cumulative time (time elapsed) from the start of the training, in which the plurality of work items shown in FIG. 5 are performed in the virtual space.

In the example shown in FIG. 11, the analysis means 13D of the work analysis device 13 visualizes a change in the time-series of the concentration level of the skill-possessing user of the VR device 11 (labeled as “model user” in FIG. 11) during the period in which the skill-possessing user of the VR device 11 is performing the plurality of work items shown in FIG. 5 in the virtual space. Furthermore, the analysis means 13D visualizes a change in the time-series of the concentration level of the non-skill-possessing user of the VR device 11 (labeled as “other user” in FIG. 11) during the period in which the non-skill-possessing user of the VR device 11 is performing the plurality of work items shown in FIG. 5 in the virtual space.

In the example shown in FIG. 11, it can be grasped that the concentration level of the skill-possessing user (model user) of the VR device 11 remains at a high value.

Furthermore, in the example shown in FIG. 11, feedback about the analysis result shown in FIG. 11 can be provided to the non-skill-possessing user of the VR device 11 after performing the training, and it is possible to grasp the differences between the change in the time-series of the concentration level of the non-skill-possessing user of the VR device 11 and the change in the time-series of the concentration level of the skill-possessing user of the VR device 11, and the like.

In addition, in the example shown in FIG. 11, an emotional analysis result (that is to say, a change in the time-series of the concentration level) of a user of the VR device 11 that has performed the work items in a procedure that is close to the optimal procedure (a skill-possessing user of the VR device 11) may be output as a model emotional pattern.

In the example shown in FIG. 1, as a result of using the technique described in the website and the like at the URL below, the analysis means 13D of the work analysis device 13 estimates the stress level of the user of the VR device 11 from the biometric information of the user of the VR device 11 that has been detected by the detection means 12A of the biosensor 12.
https://jpn.nec.com/manufacture/monozukuri/iot_mono/interview/13_emotion-analytics.html

Furthermore, the analysis means 13D visualizes the stress level of the user of the VR device 11 in the manner of the technique described in the websites and the like at the URLs above.

In order to more efficiently search for the optimal procedure to perform the plurality of work items, in the example of the work analysis system 1 according to the first example embodiment, a skill-possessing user of the VR device 11 firstly performs the plurality of work items in the virtual space, and the detection means 12A of the biosensor 12 detects biometric information of the skill-possessing user of the VR device 11. The acquisition means 13B of the work analysis device 13 acquires biometric information of the skill-possessing user of the VR device 11 that has been detected by the detection means 12A of the biosensor 12. Furthermore, the acquisition means 13B acquires information indicating whether or not the user of the VR device 11 possesses a skill (in this example, information is acquired that indicates that the user of the VR device 11 possesses the skill). The analysis means 13D of the work analysis device 13 estimates and visualizes the stress level of the skill-possessing user of the VR device 11 from the biometric information of the skill-possessing user of the VR device 11 that has been acquired by the acquisition means 13B.

When a skill-possessing user of the VR device 11 has not performed the plurality of work items in the virtual space, a non-skill-possessing user of the VR device 11 performs the plurality of work items in the virtual space, and the detection means 12A of the biosensor 12 detects biometric information of the non-skill-possessing user of the VR device 11. The acquisition means 13B of the work analysis device 13 acquires biometric information of the non-skill-possessing user of the VR device 11 that has been detected by the detection means 12A of the biosensor 12. Furthermore, the acquisition means 13B acquires information indicating whether or not the user of the VR device 11 possesses the skill (in this example, information is acquired that indicates that the user of the VR device 11 does not possess the skill). The analysis means 13D of the work analysis device 13 estimates and visualizes the stress level of the non-skill-possessing user of the VR device 11 from the biometric information of the non-skill-possessing user of the VR device 11 that has been acquired by the acquisition means 13B.

The analysis means 13D of the work analysis device 13 compares the visualized stress level of the skill-possessing users of the VR device 11, and the visualized stress level of the non-skill-possessing users of the VR device 11.

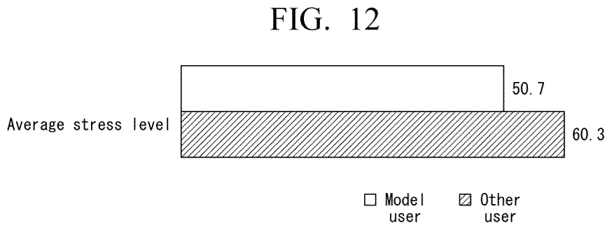

FIG. 12 is a diagram showing an example of a state in which a visualized stress level of a skill-possessing user of the VR device 11 (model user) and a visualized stress level of a non-skill-possessing user of the VR device 11 (other user) are compared.

In the example shown in FIG. 12, the analysis means 13D of the work analysis device 13 visualizes that the average stress level of the skill-possessing user of the VR device 11 (labeled as “model user” in FIG. 12) during the period in which the skill-possessing user of the VR device 11 is performing the plurality of work items shown in FIG. 5 in the virtual space is 50.7%. Furthermore, the analysis means 13D visualizes that the average stress level of the non-skill-possessing user of the VR device 11 (labeled as “other user” in FIG. 12) during the period in which the non-skill-possessing user of the VR device 11 is performing the plurality of work items shown in FIG. 5 in the virtual space is 60.3%.

In the example shown in FIG. 1, the user of the VR device 11 performs a plurality of work items in a virtual space, and the detection means 12A of the biosensor 12 detects the biometric information of the user of the VR device 11. The acquisition means 13B of the work analysis device 13 acquires biometric information of the user of the VR device 11 that has been detected by the detection means 12A of the biosensor 12. The storage means 13C of the work analysis device 13 generates and stores time-series data of the biometric information of the user of the VR device 11 from the biometric information of the user of the VR device 11 that has been acquired by the acquisition means 13B. The analysis means 13D of the work analysis device 13 estimates and analyzes a change in the time-series of the stress level of the user of the VR device 11 from the time-series data of the biometric information of the user of the VR device 11 that is stored in the storage means 13C.

In order to more efficiently search for the optimal procedure to perform the plurality of work items, in the example of the work analysis system 1 according to the first example embodiment, a skill-possessing user of the VR device 11 firstly performs the plurality of work items in the virtual space, and the detection means 12A of the biosensor 12 detects biometric information of the skill-possessing user of the VR device 11. The acquisition means 13B of the work analysis device 13 acquires biometric information of the skill-possessing user of the VR device 11 that has been detected by the detection means 12A of the biosensor 12. Furthermore, the acquisition means 13B acquires information indicating whether or not the user of the VR device 11 possesses a skill (in this example, information is acquired that indicates that the user of the VR device 11 possesses the skill). The storage means 13C of the work analysis device 13 generates and stores time-series data of the biometric information of the skill-possessing user of the VR device 11 from the biometric information of the skill-possessing user of the VR device 11 that has been acquired by the acquisition means 13B. The analysis means 13D of the work analysis device 13 estimates and visualizes a change in the time-series of the stress level of the skill-possessing user of the VR device 11 from the time-series data of the biometric information of the skill-possessing user of the VR device 11 that is stored in the storage means 13C.

When a skill-possessing user of the VR device 11 has not performed the plurality of work items in the virtual space, a non-skill-possessing user of the VR device 11 performs the plurality of work items in the virtual space, and the detection means 12A of the biosensor 12 detects biometric information of the non-skill-possessing user of the VR device 11. The acquisition means 13B of the work analysis device 13 acquires biometric information of the non-skill-possessing user of the VR device 11 that has been detected by the detection means 12A of the biosensor 12. Furthermore, the acquisition means 13B acquires information indicating whether or not the user of the VR device 11 possesses the skill (in this example, information is acquired that indicates that the user of the VR device 11 does not possess the skill). The storage means 13C of the work analysis device 13 generates and stores time-series data of the biometric information of the non-skill-possessing user of the VR device 11 from the biometric information of the non-skill-possessing user of the VR device 11 that has been acquired by the acquisition means 13B. The analysis means 13D of the work analysis device 13 estimates and visualizes a change in the time-series of the stress level of the non-skill-possessing user of the VR device 11 from the time-series data of the biometric information of the non-skill-possessing user of the VR device 11 that is stored in the storage means 13C.

In addition, the analysis means 13D compares the visualized change in the time-series of the stress level of the skill-possessing users of the VR device 11, and the visualized change in the time-series of the stress level of the non-skill-possessing users of the VR device 11.

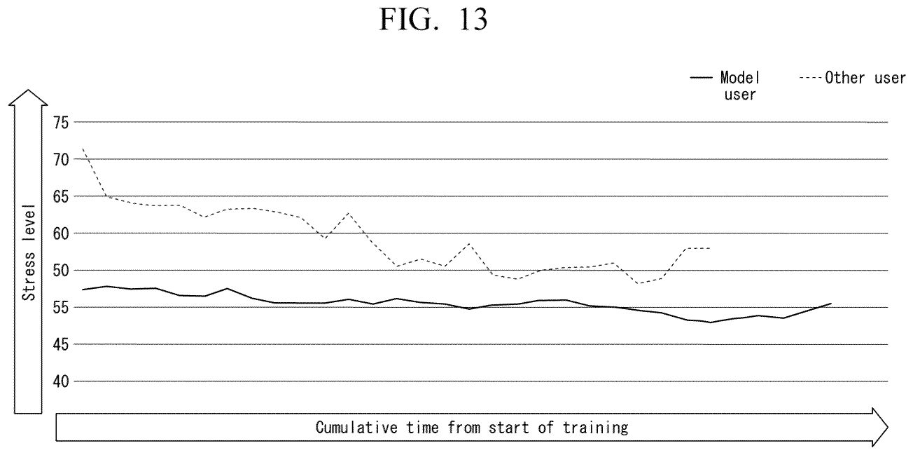

FIG. 13 is a diagram showing an example of a state in which a visualized change in a time-series of the stress level of a skill-possessing user of the VR device 11 (model user) and a visualized change in a time-series of the stress level of a non-skill-possessing user of the VR device 11 (other user) are compared. In FIG. 13, the vertical axis represents the stress level of the skill-possessing user of the VR device 11 and the non-skill-possessing user of the VR device 11, and the horizontal axis represents the cumulative time (time elapsed) from the start of the training, in which the plurality of work items shown in FIG. 5 are performed in the virtual space.

In the example shown in FIG. 13, the analysis means 13D of the work analysis device 13 visualizes a change in the time-series of the stress level of the skill-possessing user of the VR device 11 (labeled as “model user” in FIG. 13) during the period in which the skill-possessing user of the VR device 11 is performing the plurality of work items shown in FIG. 5 in the virtual space. Furthermore, the analysis means 13D visualizes a change in the time-series of the stress level of the non-skill-possessing user of the VR device 11 (labeled as “other user” in FIG. 13) during the period in which the non-skill-possessing user of the VR device 11 is performing the plurality of work items shown in FIG. 5 in the virtual space.

In the example shown in FIG. 13, it can be grasped that the stress level of the skill-possessing user of the VR device 11 (model user) is stable (that is to say, the vertical direction fluctuations (changes in the time series) in FIG. 13 are small), and remains at a low value.

Furthermore, in the example shown in FIG. 13, feedback about the analysis result shown in FIG. 13 can be provided to the non-skill-possessing user of the VR device 11 after performing the training, and it is possible to grasp the differences between the change in the time-series of the stress level of the non-skill-possessing user of the VR device 11 and the change in the time-series of the stress level of the skill-possessing user of the VR device 11, and the like.

In the example shown in FIG. 1, as a result of using the technique described in the websites and the like at the URLs below, the analysis means 13D of the work analysis device 13 analyzes the emotions of the user of the VR device 11 from the biometric information of the user of the VR device 11 that has been detected by the detection means 12A of the biosensor 12. For example, the analysis means 13D classifies emotions into four quadrants (happy, angry (stressed, irritated), relaxed, sad) by analyzing the heart rate variability of the user of the VR device 11 and expressing an emotional index on two axes, and by expressing the emotion according to a positive/negative arousal level and a pleasant/unpleasant emotion value (valence).
https://jpn.nec.com/techrep/journal/g19/n01/190109.html
https://jpn.nec.com/manufacture/monozukuri/iot_mono/interview/13_emotion-analytics.html
https://jpn.nec.com/embedded/products/emotion/index.html
https://jpn.nec.com/press/201806/20180611_01.html

In order to more efficiently search for the optimal procedure to perform the plurality of work items, in the example of the work analysis system 1 according to the first example embodiment, a skill-possessing user of the VR device 11 firstly performs the plurality of work items in the virtual space, and the detection means 12A of the biosensor 12 detects biometric information of the skill-possessing user of the VR device 11. The acquisition means 13B of the work analysis device 13 acquires biometric information of the skill-possessing user of the VR device 11 that has been detected by the detection means 12A of the biosensor 12. Furthermore, the acquisition means 13B acquires information indicating whether or not the user of the VR device 11 possesses a skill (in this example, information is acquired that indicates that the user of the VR device 11 possesses the skill). The analysis means 13D of the work analysis device 13 analyzes the emotions of the skill-possessing user of the VR device 11 from the biometric information of the skill-possessing user of the VR device 11 that has been acquired by the acquisition means 13B.

When a skill-possessing user of the VR device 11 has not performed the plurality of work items in the virtual space, a non-skill-possessing user of the VR device 11 performs the plurality of work items in the virtual space, and the detection means 12A of the biosensor 12 detects biometric information of the non-skill-possessing user of the VR device 11. The acquisition means 13B of the work analysis device 13 acquires biometric information of the non-skill-possessing user of the VR device 11 that has been detected by the detection means 12A of the biosensor 12. Furthermore, the acquisition means 13B acquires information indicating whether or not the user of the VR device 11 possesses the skill (in this example, information is acquired that indicates that the user of the VR device 11 does not possess the skill). The analysis means 13D of the work analysis device 13 analyzes the emotions of the non-skill-possessing user of the VR device 11 from the biometric information of the non-skill-possessing user of the VR device 11 that has been acquired by the acquisition means 13B.

The analysis means 13D of the work analysis device 13 compares the emotions of the skill-possessing users of the VR device 11, and the emotions of the non-skill-possessing users of the VR device 11. For example, the analysis means 13D compares the emotions of the skill-possessing user of the VR device 11 and the emotions of the non-skill-possessing user of the VR device 11 using the classification result of the four quadrants mentioned above.

That is to say, in this example, analysis of the optimal work item procedure can also be performed based on the emotional analysis result of the user of the VR device 11.

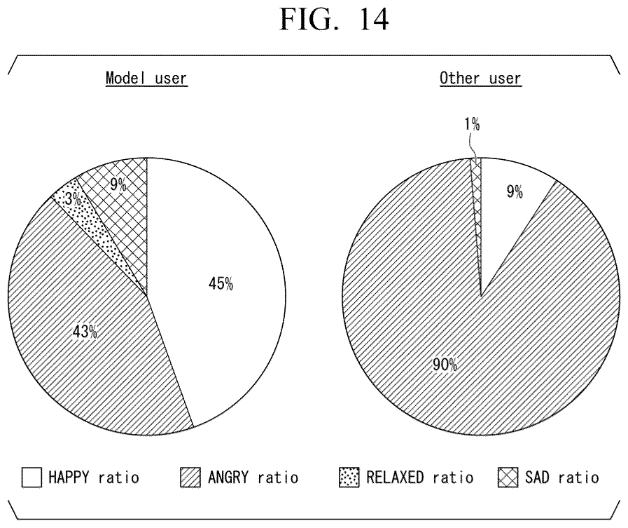

FIG. 14 is a diagram showing an example of a state in which a stress level of a skill-possessing user of the VR device 11 (model user) and the emotions of a non-skill-possessing user of the VR device 11 (other user) are compared.

In the example shown in FIG. 14, the analysis means 13D of the work analysis device 13 compares the emotions of the skill-possessing user of the VR device 11 (labeled as “model user” in FIG. 14) during the period in which the skill-possessing user of the VR device 11 is performing the plurality of work items shown in FIG. 5 in the virtual space, and the emotions of the non-skill-possessing user of the VR device 11 (labeled as “other user” in FIG. 14) during the period in which the non-skill-possessing user of the VR device 11 is performing the plurality of work items shown in FIG. 5 in the virtual space.

In order to more efficiently search for the optimal procedure to perform the plurality of work items, in the example of the work analysis system 1 according to the first example embodiment, a user of the VR device 11 firstly performs the plurality of work items in the virtual space, the motion detection means 11B of the VR device 11 detects the motions made by the user of the VR device 11 to perform the plurality of work items in the virtual space, and the detection means 12A of the biosensor 12 also detects the biometric information of the user of the VR device 11. The acquisition means 13B of the work analysis device 13 acquires data representing the motions that have been detected by the motion detection means 11B of the VR device 11 which are made by the user of the VR device 11 to perform the plurality of work items in the virtual space, and also acquires the biometric information of the user of the VR device 11 that has been detected by the detection means 12A of the biosensor 12. The storage means 13C of the work analysis device 13 generates and stores time-series data of the motions made by the user of the VR device 11 from the data acquired by the acquisition means 13B representing the motions made by the user of the VR device 11 to perform the plurality of work items in the virtual space, and also generates and stores time-series data of the biometric information of the user of the VR device 11 from the biometric information of the user of the VR device 11 that has been acquired by the acquisition means 13B.

The analysis means 13D of the work analysis device 13 determines, based on the time-series data of the motions made by the user of the VR device 11 that is stored in the storage means 13C, whether or not the user of the VR device 11 has failed at any of the plurality of work items performed in the virtual space.

In a case where the user of the VR device 11 has failed at any of the plurality of work items performed in the virtual space (specifically, in a case where the analysis means 13D has determined that the user of the VR device 11 has failed at any of the work items performed in the virtual space), the analysis means 13D extracts a change in the biometric information of the user of the VR device 11 (specifically, information in the biometric information indicating the emotions) at the timing in which the user of the VR device 11 failed at any of the plurality of work items performed in the virtual space, based on the time-series data of the biometric information of the user of the VR device 11 and the time-series data of the motions made by the user of the VR device 11 that are stored in the storage means 13C.

Furthermore, in a case where the user of the VR device 11 has succeeded at any of the plurality of work items performed in the virtual space (specifically, in a case where the analysis means 13D has determined that the user of the VR device 11 has succeeded at any of the work items performed in the virtual space), the analysis means 13D extracts a change in the biometric information of the user of the VR device 11 (specifically, information in the biometric information indicating the emotions) at the timing in which the user of the VR device 11 succeeded at any of the plurality of work items performed in the virtual space, based on the time-series data of the biometric information of the user of the VR device 11 and the time-series data of the motions made by the user of the VR device 11 that are stored in the storage means 13C.

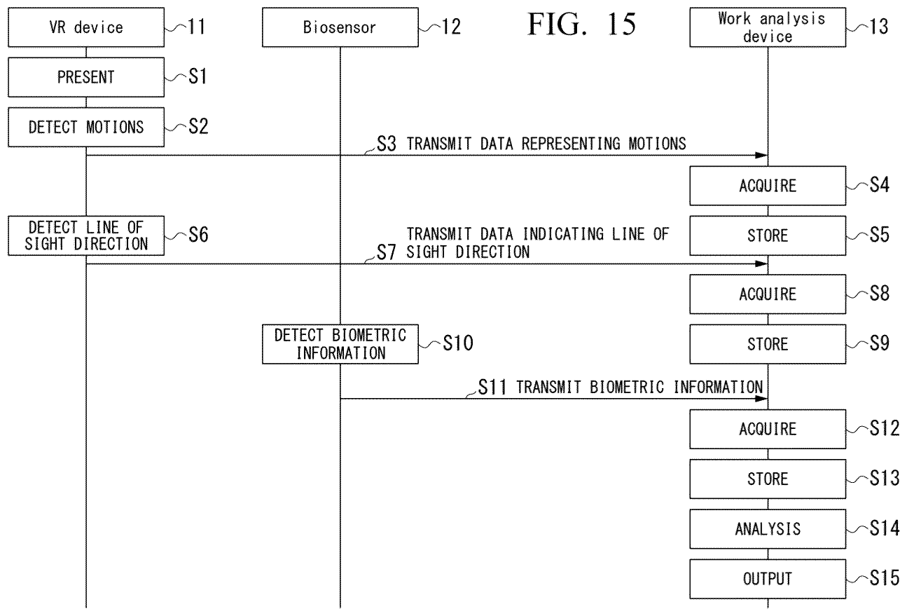

FIG. 15 is a sequence diagram for describing an example of the processing performed in the work analysis system 1 according to the first example embodiment.

In the example shown in FIG. 15, in step S1, the presentation means 11A of the VR device 11 presents a plurality of work items of a problem that has been assigned to the user of the VR device 11 in a virtual space.

Then, in step S2, the motion detection means 11B of the VR device 11 detects motions made by the user of the VR device 11 to perform the plurality of work items in the virtual space.

Next, in step S3, the communication means 11D of the VR device 11 transmits, to the work analysis device 13, data representing the motions detected in step S2 which are made by the user of the VR device 11 to perform the plurality of work items in the virtual space.

Then, in step S4, the acquisition means 13B of the work analysis device 13 acquires the data received in step S3 representing the motions which are made by the user of the VR device 11 to perform the plurality of work items in the virtual space.

Next, in step S5, the storage means 13C of the work analysis device 13 generates and stores time-series data of the motions made by the user of the VR device 11 from the data acquired in step S4 representing the motions made by the user of the VR device 11 to perform the plurality of work items in the virtual space.

Furthermore, in step S6, the line of sight direction detection means 11C of the VR device 11 detects the line of sight direction of the user of the VR device 11 who is performing the plurality of work items of a problem.

Then, in step S7, the communication means 11D of the VR device 11 transmits, to the work analysis device 13, data indicating the line of sight direction of the user of the VR device 11 detected in step S6.

Next, in step S8, the acquisition means 13B of the work analysis device 13 acquires the data received in step S7 indicating the line of sight direction of the user of the VR device 11.

Then, in step S9, the storage means 13C of the work analysis device 13 generates and stores time-series data of the line of sight direction of the user of the VR device 11 from the data acquired in step S8 indicating the line of sight direction of the user of the VR device 11.

Moreover, in step S10, the detection means 12A of the biosensor 12 detects biometric information of the user of the VR device 11 who is performing the plurality of work items of a problem.

Then, in step S11, the communication means 12B of the biosensor 12 transmits, to the work analysis device 13, the biometric information of the user of the VR device 11 detected in step S10.

Next, in step S12, the acquisition means 13B of the work analysis device 13 acquires the biometric information of the user of the VR device 11 received in step S11.

Then, in step S13, the storage means 13C of the work analysis device 13 generates and stores time-series data of the biometric information of the user of the VR device 11 from the biometric information of the user of the VR device 11 acquired in step S12.

Next, in step S14, the analysis means 13D of the work analysis device 13 visualizes the changes in the motions made by the user of the VR device 11 to perform the plurality of work items in the virtual space based on the time-series data of the motions made by the user of the VR device 11 that has been stored in step S5.

In addition, in step S14, the analysis means 13D of the work analysis device 13 visualizes a change in the line of sight direction of the user of the VR device 11 based on the time-series data of the line of sight direction of the user of the VR device 11 that has been stored in step S9.

Further, in step S14, the analysis means 13D of the work analysis device 13 estimates and analyzes a change in the time-series of the emotions of the user of the VR device 11 and the like from the time-series data of the biometric information of the user of the VR device 11 obtained from the biometric information of the user of the VR device 11 that has been stored in step S13.

Then, in step S15, the output means 13E of the work analysis device 13 outputs the result of the analysis in step S14.

According to the work analysis system 1 of the first example embodiment, it is possible to efficiently search for an optimal work item procedure in a case where an objective has been determined, but the optimal work item procedure to achieve the objective has not been determined.

### Second Example Embodiment

Hereunder, a second example embodiment of a work analysis device, a work analysis system, a work analysis method, and a recording medium of the present invention will be described.

The work analysis system 1 according to the second example embodiment has the same configuration as the work analysis system 1 according to the first example embodiment described above, except for the aspects described below. Therefore, the work analysis system 1 according to the second example embodiment can provide the same effects as the work analysis system 1 according to the first example embodiment described above, except for the aspects described below.

The work analysis system 1 according to the second example embodiment has the same configuration as the work analysis system 1 according to the first example embodiment shown in FIG. 1.

As mentioned above, in the work analysis system 1 according to the first example embodiment, the work analysis device 13 is placed in the cloud. On the other hand, in the work analysis system 1 according to the second example embodiment, for example, a smartphone used by the user of the VR device 11 and the like functions as the work analysis device 13.

### Third Example Embodiment

Hereunder, a third example embodiment of a work analysis device, a work analysis system, a work analysis method, and a recording medium of the present invention will be described.

The work analysis system 1 according to the third example embodiment has the same configuration as the work analysis system 1 according to the first example embodiment described above, except for the aspects described below. Therefore, the work analysis system 1 according to the third example embodiment can provide the same effects as the work analysis system 1 according to the first example embodiment described above, except for the aspects described below.

The work analysis system 1 according to the third example embodiment has the same configuration as the work analysis system 1 according to the first example embodiment shown in FIG. 1.

As mentioned above, in the work analysis system 1 according to the first example embodiment, the work analysis device 13 is placed in the cloud. On the other hand, in the work analysis system 1 according to the third example embodiment, for example, a terminal device (such as a personal computer) used by the user of the VR device 11 and the like functions as the work analysis device 13.

### Fourth Example Embodiment

Hereunder, a fourth example embodiment of a work analysis device, a work analysis system, a work analysis method, and a recording medium of the present invention will be described.

The work analysis system 1 according to the fourth example embodiment has the same configuration as the work analysis system 1 according to the first example embodiment described above, except for the aspects described below. Therefore, the work analysis system 1 according to the fourth example embodiment can provide the same effects as the work analysis system 1 according to the first example embodiment described above, except for the aspects described below.

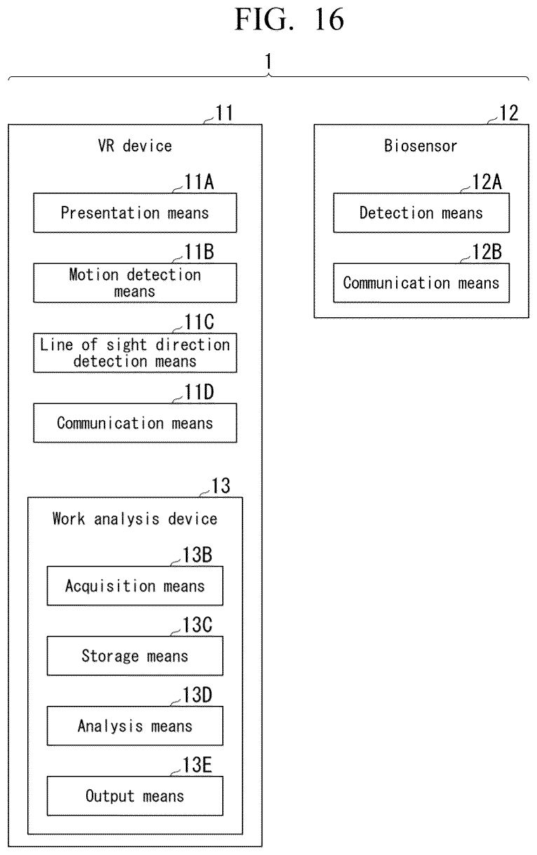

FIG. 16 is a diagram showing an example of a work analysis system 1 according to the fourth example embodiment.

In the example shown in FIG. 16, the work analysis system 1 includes a VR device 11 and a biosensor 12. The VR device 11 includes a presentation means 11A, a motion detection means 11B, a line of sight direction detection means 11C, a communication means 11D, and a work analysis device 13. That is to say, the work analysis device 13 is built into the VR device 11.

In the example shown in FIG. 16, the communication means 11D communicates with the biosensor 12 and the like.

The communication means 12B of the biosensor 12 communicates with the VR device 11 and the like. The communication means 12B transmits, to the VR device 11, biometric information of the user of the VR device 11 that has been detected by the detection means 12A.

The work analysis device 13 includes an acquisition means 13B, a storage means 13C, an analysis means 13D, and an output means 13E. The acquisition means 13B acquires the data detected by the motion detection means 11B of the VR device 11 representing the motions made by the user of the VR device 11 to perform the plurality of work items in the virtual space, the data detected by the line of sight direction detection means 11C of the VR device 11 indicating the line of sight direction of the user of the VR device 11, and the biometric information of the user of the VR device 11 received by the communication means 11D of the VR device 11.

### Fifth Example Embodiment

Hereunder, a fifth example embodiment of a work analysis device, a work analysis system, a work analysis method, and a recording medium of the present invention will be described.

The work analysis system 1 according to the fifth example embodiment has the same configuration as the work analysis system 1 according to the first example embodiment described above, except for the aspects described below. Therefore, the work analysis system 1 according to the fifth example embodiment can provide the same effects as the work analysis system 1 according to the first example embodiment described above, except for the aspects described below.

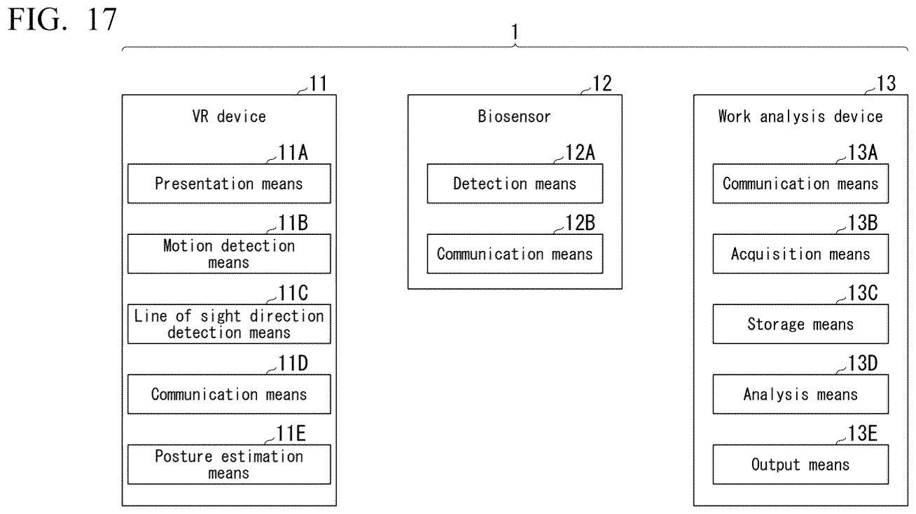

FIG. 17 is a diagram showing an example of a work analysis system 5 according to the fifth example embodiment.

In the example shown in FIG. 17, the VR device 11 includes a presentation means 11A, a motion detection means 11B, a line of sight direction detection means 11C, a communication means 11D, and a posture estimation means 11E. The posture estimation means 11E estimates the posture of the user of the VR device 11 by using, for example, a technique such as that described in the websites at the URLs below.
https://jpn.nec.com/techrep/journal/g16/n02/160207.html
http://mikilab.doshisha.ac.jp/research/master_thesis/2019/03_kfujimoto.pdf
https://www.ieice.org/publications/ken/summary.php?contribution_id=KJ000095
http://conference.vrsj.org/ac2020/program/doc/1C1-2_PR0064.pdf

In the example shown in FIG. 17, the communication means 11D transmits, to the work analysis device 13, data indicating the posture of the user of the VR device 11 that has been estimated by the posture estimation means 11E. The communication means 13A of the work analysis device 13 receives the data indicating the posture of the user of the VR device 11 that has been transmitted by the communication means 11D of the VR device 11. The acquisition means 13B of the work analysis device 13 acquires the data indicating the posture of the user of the VR device 11 that has been received by the communication means 13A. That is to say, the acquisition means 13B acquires the data indicating the posture of the user of the VR device 11 that has been detected by the posture estimation means 11E of the VR device 11. The storage means 13C of the work analysis device 13 generates and stores time-series data of the posture of the user of the VR device 11 from the data (that is to say, instantaneous data) acquired by the acquisition means 13B indicating the posture of the user of the VR device 11. The analysis means 13D of the work analysis device 13 analyzes the posture of the user of the VR device 11 based on the time-series data of the posture of the user of the VR device 11 that is stored in the storage means 13C. The analysis means 13D analyzes the posture of the user of the VR device 11, for example, during the period in which the user of the VR device 11 is performing a predetermined work item.

### Sixth Example Embodiment

Hereunder, a sixth example embodiment of a work analysis device, a work analysis system, a work analysis method, and a recording medium of the present invention will be described.

The work analysis system 1 according to the sixth example embodiment has the same configuration as the work analysis system 1 according to the first example embodiment described above, except for the aspects described below. Therefore, the work analysis system 1 according to the sixth example embodiment can provide the same effects as the work analysis system 1 according to the first example embodiment described above, except for the aspects described below.

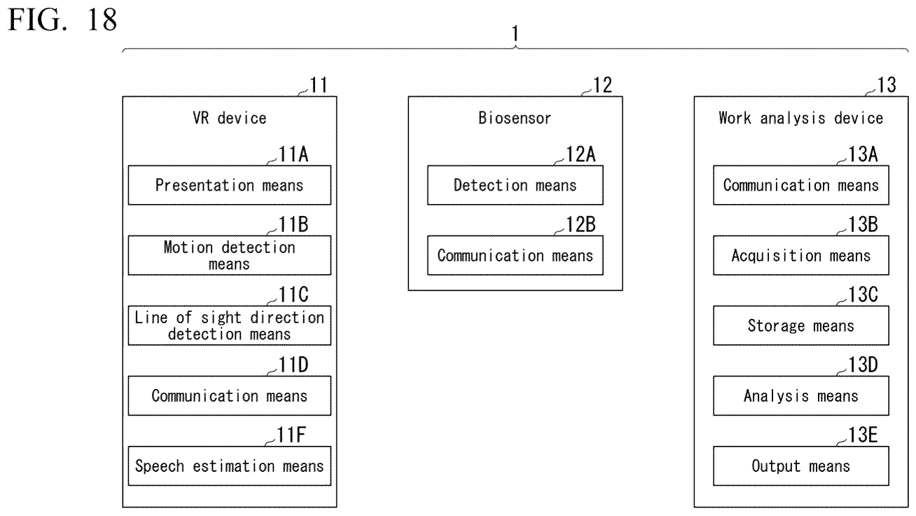

FIG. 18 is a diagram showing an example of a work analysis system 1 according to the sixth example embodiment.

In the example shown in FIG. 18, the VR device 11 includes a presentation means 11A, a motion detection means 11B, a line of sight direction detection means 11C, a communication means 11D, and a speech estimation means 11F. The speech estimation means 11E estimates the speech of the user of the VR device 11 by using, for example, a technique such as that described in the websites at the URLs below.
https://jpn.nec.com/techrep/journal/g12/n03/pdf/120326.pdf
https://jpn.nec.com/ir/pdf/library/090629/090629_04.pdf
https://jpn.nec.com/techrep/journal/g10/n01/pdf/100112.pdf
https://jpn.nec.com/techrep/journal/g14/n01/pdf/140118.pdf

http://www.nec.co.jp/press/ja/0809/2502.html

In the example shown in FIG. 18, the communication means 11D transmits, to the work analysis device 13, data representing the speech of the user of the VR device 11 that has been estimated by the speech estimation means 11F. The communication means 13A of the work analysis device 13 receives the data representing the speech of the user of the

VR device 11 that has been transmitted by the communication means 11D of the VR device 11. The acquisition means 13B of the work analysis device 13 acquires the data representing the speech of the user of the VR device 11 that has been received by the communication means 13A. That is to say, the acquisition means 13B acquires the data representing the speech of the user of the VR device 11 that has been detected by the speech estimation means 11F of the VR device 11. The storage means 13C of the work analysis device 13 generates and stores time-series data of the speech of the user of the VR device 11 from the data (that is to say, instantaneous data) acquired by the acquisition means 13B representing the speech of the user of the VR device 11. The analysis means 13D of the work analysis device 13 analyzes the speech of the user of the VR device 11 based on the time-series data of the speech of the user of the VR device 11 that is stored in the storage means 13C.

### Seventh Example Embodiment

Hereunder, a seventh example embodiment of a work analysis device, a work analysis system, a work analysis method, and a recording medium of the present invention will be described.

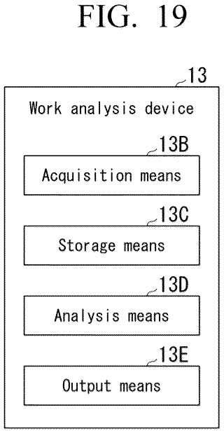

FIG. 19 is a diagram showing an example of a work analysis device 13 according to a seventh example embodiment. In the example shown in FIG. 19, the work analysis device 13 includes an acquisition means 13B, a storage means 13C, an analysis means 13D, and an output means 13E. The acquisition means 13B acquires data that has been detected by the VR device 11, which presents a plurality of work items of a problem in a virtual space, representing the motions made by a user of the VR device 11 to perform the plurality of work items in the virtual space, and data indicating the line of sight direction of the user of the VR device 11 that has been detected by the VR device 11. The storage means 13C generates and stores time-series data of the motions made by the user of the VR device 11 from the data acquired by the acquisition means 13B representing the motions made by the user of the VR device 11 to perform the plurality of work items in the virtual space, and also generates and stores time-series data of the line of sight direction of the user of the VR device 11 from the data indicating the line of sight direction of the user of the VR device 11 that has been acquired by the acquisition means 13B. At the very least, the analysis means 13D visualizes the changes in the motions made by the user of the VR device 11 to perform the plurality of work items in the virtual space based on the time-series data of the motions made by the user of the VR device 11 that is stored in the storage means 13C, and visualizes the changes in the line of sight direction of the user of the VR device 11 based on the time-series data of the line of sight direction of the user of the VR device 11 that is stored in the storage means 13C. The output means 13E outputs an analysis result from the analysis means 13D.

The work analysis device 13 described above has an internal computer system. Further, the processing sequences of the work analysis system 1 described above are stored in a program format in a computer-readable recording medium, and the processing above is performed by a computer reading and executing the program. The computer-readable recording medium refers to a portable medium such as a flexible disk, a magnetic optical disk, a ROM, or a CD-ROM, or a storage device such as a hard disk built into a computer system. Furthermore, the computer program may be transmitted to a computer by a communication line, and the computer receiving the transmission may execute the program.

Some or all of the functions of each unit included in the work analysis device 13 according to the example embodiments described above may be realized by recording a program for realizing the functions in a computer-readable recording medium, and then causing a computer system to read and execute the program recorded on the recording medium. The “computer system” referred to here is assumed to include an OS and hardware such as a peripheral device. The “computer system” is also assumed to include a WWW system provided with a homepage providing environment (or display environment). Furthermore, the “computer-readable recording medium” refers to a portable medium such as a flexible disk, a magnetic optical disk, a ROM, or a CD-ROM, or a storage device such as a hard disk built into a computer system. In addition, the “computer-readable recording medium” is assumed to include those that retain the program for a fixed time, such as the volatile memory (RAM) inside a computer system serving as a server or a client in a case where the program is transmitted via a network such as the Internet, or a communication line such as a telephone line.

Furthermore, the program described above may be transmitted from a computer system storing the program in a storage device, or the like, to another computer system via a transmission medium or by a transmission wave in the transmission medium. Here, the “transmission medium” that transmits the program refers to a medium having an information transmission function, such as a network (communication network) such as the Internet, or a communication line (communication wire) such as a telephone line. Moreover, the program described above may be for realizing some of the functions mentioned above. In addition, the program may be one that realizes the functions mentioned above by being combined with a program already recorded on the computer system, as a so-called difference file (difference program).

In addition, substitution of the configuration elements in the embodiments described above with known configuration elements may be made as appropriate within a scope not departing from the spirit of the present invention. Moreover, the technical scope of the present invention is not limited to the example embodiments above, and various changes may be applied within a scope not departing from the spirit of the present invention.

The whole or part of the example embodiments above can be described as the supplementary notes below, but the embodiment is not limited thereto.
(Supplementary note 1) A work analysis device comprising: an acquisition means that acquires data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device; a storage means that generates and stores time-series data of the motions made by the user of the VR device from the data representing the motions made by the user of the VR device to perform the plurality of work items in the virtual space that has been acquired by the acquisition means, and generates and stores time-series data of the line of sight direction of the user of the VR device from the data representing the line of sight direction of the user of the VR device that has been acquired by the acquisition means; an analysis means that visualizes changes in the motions made by the user of the VR device to perform the plurality of work items in the virtual space based on at least the time-series data of the motions made by the user of the VR device that is stored in the storage means, and visualizes changes in the line of sight direction of the user of the VR device based on the time-series data of the line of sight direction of the user of the VR device that is stored in the storage means; and an output means that outputs an analysis result by the analysis means.
(Supplementary note 2) The work analysis device according to supplementary note 1, wherein the analysis means generates a trajectory of execution positions of the plurality of work items performed by the user of the VR device in the virtual space based on the time-series data of the motions made by the user of the VR device that is stored in the storage means.
(Supplementary note 3) The work analysis device according to supplementary note 2, wherein the acquisition means acquires data representing motions that have been detected by the VR device and which are made by one user of the VR device to perform the plurality of work items in the virtual space, and data representing motions that have been detected by the VR device and which are made by another user of the VR device to perform the plurality of work items in the virtual space, the storage means generates and stores time-series data of the motions made by the one user of the VR device from the data representing the motions made by the one user of the VR device to perform the plurality of work items in the virtual space that has been acquired by the acquisition means, and generates and stores time-series data of the motions made by the other user of the VR device from the data representing the motions made by the other user of the VR device to perform the plurality of work items in the virtual space that has been acquired by the acquisition means, and the analysis means generates a trajectory of execution positions of the plurality of work items performed by the one user of the VR device in the virtual space based on the time-series data of the motions made by the one user of the VR device that is stored in the storage means, generates a trajectory of execution positions of the plurality of work items performed by the other user of the VR device in the virtual space based on the time-series data of the motions made by the other user of the VR device that is stored in the storage means, and compares the trajectory of the execution positions of the plurality of work items performed by the one user of the VR device in the virtual space and the trajectory of the execution positions of the plurality of work items performed by the other user of the VR device in the virtual space.
(Supplementary note 4) The work analysis device according to supplementary note 2, wherein the acquisition means acquires information indicating whether the user of the VR device is right-handed or left-handed, the acquisition means acquires data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space, the storage means generates and stores time-series data of the motions made by the right-handed user of the VR device from the data representing the motions made by the right-handed user of the VR device to perform the plurality of work items in the virtual space that has been acquired by the acquisition means, and generates and stores time-series data of the motions made by the left-handed user of the VR device from the data representing the motions made by the left-handed user of the VR device to perform the plurality of work items in the virtual space that has been acquired by the acquisition means, and the analysis means generates a trajectory of execution positions of the plurality of work items performed by the right-handed user of the VR device in the virtual space based on the time-series data of the motions made by the right-handed user of the VR device that is stored in the storage means, generates a trajectory of execution positions of the plurality of work items performed by the left-handed user of the VR device in the virtual space based on the time-series data of the motions made by the left-handed user of the VR device that is stored in the storage means, and compares the trajectory of the execution positions of the plurality of work items performed by the right-handed user of the VR device in the virtual space and the trajectory of the execution positions of the plurality of work items performed by the left-handed user of the VR device in the virtual space.
(Supplementary note 5) The work analysis device according to supplementary note 2, wherein the acquisition means acquires information indicating whether or not a user of the VR device possesses a skill, data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space, the storage means generates and stores time-series data of the motions made by the skill-possessing user of the VR device from the data representing the motions made by the skill-possessing user of the VR device to perform the plurality of work items in the virtual space that has been acquired by the acquisition means, and generates and stores time-series data of the motions made by the non-skill-possessing user of the VR device from the data representing the motions made by the non-skill-possessing user of the VR device to perform the plurality of work items in the virtual space that has been acquired by the acquisition means, and the analysis means generates a trajectory of execution positions of the plurality of work items performed by the skill-possessing user of the VR device in the virtual space based on the time-series data of the motions made by the skill-possessing user of the VR device that is stored in the storage means, generates a trajectory of execution positions of the plurality of work items performed by the non-skill-possessing user of the VR device in the virtual space based on the time-series data of the motions made by the non-skill-possessing user of the VR device that is stored in the storage means, and compares the trajectory of the execution positions of the plurality of work items performed by the skill-possessing user of the VR device in the virtual space and the trajectory of the execution positions of the plurality of work items performed by the non-skill-possessing user of the VR device in the virtual space.
(Supplementary note 6) The work analysis device according to supplementary note 5, wherein the acquisition means acquires data representing motions that have been detected by the VR device which are made by each of a plurality of skill-possessing users of the VR device to perform the plurality of work items in the virtual space, the storage means generates and stores time-series data of the motions made by each of the plurality of skill-possessing users of the VR device from the data representing the motions made by each of the plurality of skill-possessing users of the VR device to perform the plurality of work items in the virtual space that has been acquired by the acquisition means, and the analysis means generates trajectories of execution positions of the plurality of work items performed by each of the plurality of skill-possessing users of the VR device in the virtual space based on the time-series data of the motions made by each of the plurality of skill-possessing users of the VR device that is stored in the storage means, and extracts and visualizes a trajectory that satisfies a first condition from the trajectories of the plurality of skill-possessing users of the VR device.
(Supplementary note 7) The work analysis device according to supplementary note 5, wherein the acquisition means acquires data representing motions that have been detected by the VR device which are made by each of a plurality of skill-possessing users of the VR device to perform the plurality of work items in the virtual space, the storage means generates and stores time-series data of the motions made by each of the plurality of skill-possessing users of the VR device from the data representing the motions made by each of the plurality of skill-possessing users of the VR device to perform the plurality of work items in the virtual space that has been acquired by the acquisition means, and the analysis means generates trajectories of execution positions of the plurality of work items performed by each of the plurality of skill-possessing users of the VR device in the virtual space based on the time-series data of the motions made by each of the plurality of skill-possessing users of the VR device that is stored in the storage means, and extracts trajectories, from the trajectories of the plurality of skill-possessing users, that satisfy a second condition in which an execution order of the work items has a same tendency, and groups and assembles the trajectories into tabular data.
(Supplementary note 8) The work analysis device according to supplementary note 5, wherein the acquisition means acquires data representing motions that have been detected by the VR device which are made by each of a plurality of skill-possessing users of the VR device to perform the plurality of work items in the virtual space, the storage means generates and stores time-series data of the motions made by each of the plurality of skill-possessing users of the VR device from the data representing the motions made by each of the plurality of skill-possessing users of the VR device to perform the plurality of work items in the virtual space that has been acquired by the acquisition means, and the analysis means generates trajectories of execution positions of the plurality of work items performed by each of the plurality of skill-possessing users of the VR device in the virtual space based on the time-series data of the motions made by each of the plurality of skill-possessing users of the VR device that is stored in the storage means, and extracts, from the trajectories of the plurality of skill-possessing users of the VR device, an execution position of a first work item and an execution position of a final work item for a predetermined proportion or more of the trajectories.
(Supplementary note 9) The work analysis device according to supplementary note 8, wherein the acquisition means acquires information indicating whether the user of the VR device is right-handed or left-handed, data representing motions that have been detected by the VR device which are made by each of the plurality of skill-possessing right-handed users of the VR device to perform the plurality of work items in the virtual space, and data representing motions that have been detected by the VR device which are made by each of the plurality of skill-possessing left-handed users of the VR device to perform the plurality of work items in the virtual space, the storage means generates and stores time-series data of the motions made by each of the plurality of skill-possessing right-handed users of the VR device from the data representing the motions made by each of the plurality of skill-possessing right-handed users of the VR device to perform the plurality of work items in the virtual space that has been acquired by the acquisition means, and generates and stores time-series data of the motions made by each of the plurality of skill-possessing left-handed users of the VR device from the data representing the motions made by each of the plurality of skill-possessing left-handed users of the VR device to perform the plurality of work items in the virtual space that has been acquired by the acquisition means, and the analysis means generates trajectories of execution positions of the plurality of work items performed by each of the plurality of skill-possessing right-handed users of the VR device in the virtual space based on the time-series data of the motions made by each of the plurality of skill-possessing right-handed users of the VR device that is stored in the storage means, and generates trajectories of execution positions of the plurality of work items performed by each of the plurality of skill-possessing left-handed users of the VR device in the virtual space based on the time-series data of the motions made by each of the plurality of skill-possessing left-handed users of the VR device that is stored in the storage means, and extracts, from the trajectories of the plurality of skill-possessing right-handed users of the VR device, an execution position of a first work item and an execution position of a final work item for the predetermined proportion or more of the trajectories, and extracts, from the trajectories of the plurality of skill-possessing left-handed users of the VR device, an execution position of a first work item and an execution position of a final work item for the predetermined proportion or more of the trajectories.
(Supplementary note 10) The work analysis device according to supplementary note 1, wherein the acquisition means acquires information indicating a correct execution order, which is an execution order that is correct for a plurality of work items of a problem that has been specified in advance, the storage means stores the information indicating the correct execution order acquired by the acquisition means, and the analysis means determines whether or not an execution order of the plurality of work items performed by the user of the VR device in the virtual space matches the correct execution order.
(Supplementary note 11) The work analysis device according to supplementary note 10, wherein the acquisition means acquires information indicating whether or not the user of the VR device possesses a skill, data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space, the storage means generates and stores time-series data of the motions made by the skill-possessing user of the VR device from the data representing the motions made by the skill-possessing user of the VR device to perform the plurality of work items in the virtual space that has been acquired by the acquisition means, and generates and stores time-series data of the motions made by the non-skill-possessing user of the VR device from the data representing the motions made by the non-skill-possessing user of the VR device to perform the plurality of work items in the virtual space that has been acquired by the acquisition means, and the analysis means determines whether or not an execution order of the plurality of work items performed by the skill-possessing user of the VR device in the virtual space matches the correct execution order, determines whether or not an execution order of the plurality of work items performed by the non-skill-possessing user of the VR device in the virtual space matches the correct execution order, and compares a determination result of whether or not the execution order of the plurality of work items performed by the skill-possessing user of the VR device in the virtual space matches the correct execution order, and a determination result of whether or not the execution order of the plurality of work items performed by the non-skill-possessing user of the VR device in the virtual space matches the correct execution order.
(Supplementary note 12) The work analysis device according to supplementary note 10, wherein the acquisition means acquires information indicating whether the user of the VR device is right-handed or left-handed, data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space, the storage means generates and stores time-series data of the motions made by the right-handed user of the VR device from the data representing the motions made by the right-handed user of the VR device to perform the plurality of work items in the virtual space that has been acquired by the acquisition means, and generates and stores time-series data of the motions made by the left-handed user of the VR device from the data representing the motions made by the left-handed user of the VR device to perform the plurality of work items in the virtual space that has been acquired by the acquisition means, and the analysis means determines whether or not an execution order of the plurality of work items performed by the right-handed user of the VR device in the virtual space matches the correct execution order, determines whether or not an execution order of the plurality of work items performed by the left-handed user of the VR device in the virtual space matches the correct execution order, and compares a determination result of whether or not the execution order of the plurality of work items performed by the right-handed user of the VR device in the virtual space matches the correct execution order, and a determination result of whether or not the execution order of the plurality of work items performed by the left-handed user of the VR device in the virtual space matches the correct execution order.
(Supplementary note 13) The work analysis device according to supplementary note 1, wherein the acquisition means acquires information indicating a first correct execution order, which is an execution order that is correct for first and subsequent work items from among the plurality of work items of the problem, and information indicating a second correct execution order, which is an execution order that is correct for second and subsequent work items, the storage means stores the information indicating the first correct execution order and the information indicating the second correct execution order acquired by the acquisition means, and the analysis means determines whether or not an execution order of a plurality of work items including the first and subsequent work items performed by the user of the VR device in the virtual space matches the first correct execution order, and whether or not an execution order of a plurality of work items including the second and subsequent work items performed by the user of the VR device in the virtual space matches the second correct execution order.
(Supplementary note 14) The work analysis device according to supplementary note 10, wherein the analysis means determines, for each execution position of the work items, whether or not the execution order of the plurality of work items performed by the user of the VR device in the virtual space matches the correct execution order.
(Supplementary note 15) The work analysis device according to supplementary note 14, wherein the acquisition means acquires information indicating whether the user of the VR device is right-handed or left-handed, data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space, the storage means generates and stores time-series data of the motions made by the right-handed user of the VR device from the data representing the motions made by the right-handed user of the VR device to perform the plurality of work items in the virtual space that has been acquired by the acquisition means, and generates and stores time-series data of the motions made by the left-handed user of the VR device from the data representing the motions made by the left-handed user of the VR device to perform the plurality of work items in the virtual space that has been acquired by the acquisition means, and the analysis means determines, for each execution position of the work items, whether or not the execution order of the plurality of work items performed by the right-handed user of the VR device in the virtual space matches the correct execution order, and determines, for each execution position of the work items, whether or not the execution order of the plurality of work items performed by the left-handed user of the VR device in the virtual space matches the correct execution order.
(Supplementary note 16) The work analysis device according to supplementary note 14, wherein the acquisition means acquires information indicating whether or not the user of the VR device possesses a skill, data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space, the storage means generates and stores time-series data of the motions made by the skill-possessing user of the VR device from the data representing the motions made by the skill-possessing user of the VR device to perform the plurality of work items in the virtual space that has been acquired by the acquisition means, and generates and stores time-series data of the motions made by the non-skill-possessing user of the VR device from the data representing the motions made by the non-skill-possessing user of the VR device to perform the plurality of work items in the virtual space that has been acquired by the acquisition means, and the analysis means determines, for each execution position of the work items, whether or not the execution order of the plurality of work items performed by the skill-possessing user of the VR device in the virtual space matches the correct execution order, determines, for each execution position of the work items, whether or not the execution order of the plurality of work items performed by the non-skill-possessing user of the VR device in the virtual space matches the correct execution order, and compares, for each execution position of the work items, a determination result of whether or not the execution order of the plurality of work items performed by the skill-possessing user of the VR device in the virtual space matches the correct execution order, and a determination result of whether or not the execution order of the plurality of work items performed by the non-skill-possessing user of the VR device in the virtual space matches the correct execution order.
(Supplementary note 17) The work analysis device according to supplementary note 10, wherein the analysis means determines whether or not the execution order of the plurality of work items performed by each of the plurality of users of the VR device in the virtual space matches the correct execution order, and extracts, from among the plurality of work items of the problem, a work item in which a probability of each of the plurality of users of the VR device performing an execution order that is different from the correct execution order is higher than a predetermined threshold.
(Supplementary note 18) The work analysis device according to supplementary note 17, wherein the acquisition means acquires information indicating whether the user of the VR device is right-handed or left-handed, data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space, the storage means generates and stores time-series data of the motions made by the right-handed user of the VR device from the data representing the motions made by the right-handed user of the VR device to perform the plurality of work items in the virtual space that has been acquired by the acquisition means, and generates and stores time-series data of the motions made by the left-handed user of the VR device from the data representing the motions made by the left-handed user of the VR device to perform the plurality of work items in the virtual space that has been acquired by the acquisition means, and the analysis means determines whether or not the execution order of the plurality of work items performed by each of the plurality of right-handed users of the VR device in the virtual space matches the correct execution order, extracts, from among the plurality of work items of the problem, work items in which a probability of each of the plurality of right-handed users of the VR device performing an execution order that is different from the correct execution order is higher than the predetermined threshold, determines whether or not the execution order of the plurality of work items performed by each of the plurality of left-handed users of the VR device in the virtual space matches the correct execution order, and extracts, from among the plurality of work items of the problem, work items in which a probability of each of the plurality of left-handed users of the VR device performing an execution order that is different from the correct execution order is higher than the predetermined threshold.
(Supplementary note 19) The work analysis device according to supplementary note 1, wherein the analysis means generates a trajectory of the line of sight direction of the user of the VR device based on the time-series data of the line of sight direction of the user of the VR device that is stored in the storage means.
(Supplementary note 20) The work analysis device according to supplementary note 1, wherein the acquisition means acquires information indicating the plurality of work items of the problem that the user of the VR device needs to perform in the virtual space, and the analysis means extracts, from among the plurality of work items of the problem indicated by the information acquired by the acquisition means, a work item that the user of the VR device has not performed in the virtual space as a work item that has been overlooked by the user of the VR device.
(Supplementary note 21) The work analysis device according to supplementary note 20, wherein the acquisition means acquires information indicating whether the user of the VR device is right-handed or left-handed, and the analysis means extracts, from among the plurality of work items of the problem indicated by the information acquired by the acquisition means, a work item that the right-handed user of the VR device has not performed in the virtual space as a work item that has been overlooked by the right-handed user of the VR device, and extracts, from among the plurality of work items of the problem indicated by the information acquired by the acquisition means, a work item that the left-handed user of the VR device has not performed in the virtual space as a work items that has been overlooked by the left-handed user of the VR device.
(Supplementary note 22) The work analysis device according to supplementary note 1, wherein the analysis means extracts, based on the time-series data of the motions of the user of the VR device and the time-series data of the line of sight direction of the user of the VR device that are stored in the storage means, a timing in which the line of sight direction of the user of the VR device is not facing an execution position of a work item performed by the user of the VR device in the virtual space.
(Supplementary note 23) The work analysis device according to supplementary note 22, wherein the acquisition means acquires information indicating whether the user of the VR device is right-handed or left-handed, acquires data representing motions that have been detected by the VR device and which are made by a right-handed user of the VR device to perform the plurality of work items in the virtual space, data representing motions that have been detected by the VR device and which are made by a left-handed user of the VR device to perform the plurality of work items in the virtual space, data representing a line of sight direction of the right-handed user of the VR device that has been detected by the VR device, and data representing a line of sight direction of the left-handed user of the VR device that has been detected by the VR device, the storage means generates and stores time-series data of the motions made by the right-handed user of the VR device from the data representing the motions made by the right-handed user of the VR device to perform the plurality of work items in the virtual space that has been acquired by the acquisition means, and generates and stores time-series data of the line of sight direction of the right-handed user of the VR device from the data representing the line of sight direction of the right-handed user of the VR device that has been acquired by the acquisition means, and generates and stores time-series data of the motions made by the left-handed user of the VR device from the data representing the motions made by the left-handed user of the VR device to perform the plurality of work items in the virtual space that has been acquired by the acquisition means, and generates and stores time-series data of the line of sight direction of the left-handed user of the VR device from the data representing the line of sight direction of the left-handed user of the VR device that has been acquired by the acquisition means, and the analysis means extracts, based on the time-series data of the motions of the right-handed user of the VR device and the time-series data of the line of sight direction of the right-handed user of the VR device that are stored in the storage means, a timing in which the line of sight direction of the right-handed user of the VR device is not facing an execution position of a work item performed by the right-handed user of the VR device in the virtual space, and extracts, based on the time-series data of the motions of the left-handed user of the VR device and the time-series data of the line of sight direction of the left-handed user of the VR device that are stored in the storage means, a timing in which the line of sight direction of the left-handed user of the VR device is not facing an execution position of a work item performed by the left-handed user of the VR device in the virtual space.
(Supplementary note 24) The work analysis device according to supplementary note 1, wherein the acquisition means acquires information indicating whether or not the user of the VR device possesses a skill, and data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space, the storage means generates and stores time-series data of the motions made by the skill-possessing user of the VR device from the data representing the motions made by the skill-possessing user of the VR device to perform the plurality of work items in the virtual space that has been acquired by the acquisition means, and generates and stores time-series data of the motions made by the non-skill-possessing user of the VR device from the data representing the motions made by the non-skill-possessing user of the VR device to perform the plurality of work items in the virtual space that has been acquired by the acquisition means, and the analysis means compares the time-series data of the motions made by the skill-possessing user of the VR device, and the time-series data of the motions made by the non-skill-possessing user of the VR device that are stored in the storage means.
(Supplementary note 25) The work analysis device according to supplementary note 24, wherein the acquisition means acquires data representing a line of sight direction of the skill-possessing user of the VR device that has been detected by the VR device, and data representing a line of sight direction of the non-skill-possessing user of the VR device that has been detected by the VR device, the storage means generates and stores time-series data of the line of sight direction of the skill-possessing user of the VR device from the data representing the line of sight direction of the skill-possessing user of the VR device that has been acquired by the acquisition means, and generates and stores time-series data of the line of sight direction of the non-skill-possessing user of the VR device from the data representing the line of sight direction of the non-skill-possessing user of the VR device that has been acquired by the acquisition means, and the analysis means compares the time-series data of the line of sight direction of the skill-possessing user of the VR device, and the time-series data of the line of sight direction of the non-skill-possessing user of the VR device that are stored in the storage means.
(Supplementary note 26) The work analysis device according to supplementary note 1 or 25, wherein the acquisition means acquires biometric information of a skill-possessing user of the VR device that has been detected by the biosensor, and biometric data of a non-skill-possessing user of the VR device by the biosensor, the storage means generates and stores time-series data of the biometric information of the skill-possessing user of the VR device from the biometric information of the skill-possessing user of the VR device that has been acquired by the acquisition means, and generates and stores time-series data of the biometric information of the non-skill-possessing user of the VR device from the biometric information of the non-skill-possessing user of the VR device that has been acquired by the acquisition means, and the analysis means compares the time-series data of the biometric information of the skill-possessing user of the VR device, and the time-series data of the biometric information of the non-skill-possessing user of the VR device that are stored in the storage means.
(Supplementary note 27) The work analysis device according to supplementary note 26, wherein the analysis means estimates a concentration level of the user of the VR device from the biometric information of the user of the VR device that has been detected by the biosensor.
(Supplementary note 28) The work analysis device according to supplementary note 27, wherein the analysis means visualizes the concentration level of the user of the VR device.
(Supplementary note 29) The work analysis device according to supplementary note 28, wherein the acquisition means acquires information indicating whether or not the user of the VR device possesses a skill, biometric information of a skill-possessing user of the VR device that has been detected by the biosensor, and biometric data of a non-skill-possessing user of the VR device that has been detected by the biosensor, and the analysis means estimates and visualizes a concentration level of the skill-possessing user of the VR device from the biometric information of the skill-possessing user of the VR device that has been acquired by the acquisition means, estimates and visualizes a concentration level of the non-skill-possessing user of the VR device from the biometric information of the non-skill-possessing user of the VR device that has been acquired by the acquisition means, and compares the visualized concentration level of the skill-possessing user of the VR device and the visualized concentration level of the non-skill-possessing user of the VR device.
(Supplementary note 30) The work analysis device according to supplementary note 1, wherein the acquisition means acquires biometric information of the user of the VR device that has been detected by a biosensor, the storage means generates and stores time-series data of the biometric information of the user of the VR device from the biometric information of the user of the VR device that has been acquired by the acquisition means, and the analysis means estimates and analyzes a change in a time-series of a concentration level of the user of the VR device from the time-series data of the biometric information of the user of the VR device that is stored in the storage means.
(Supplementary note 31) The work analysis device according to supplementary note 30, wherein the acquisition means acquires information indicating whether or not the user of the VR device possesses a skill, biometric information of a skill-possessing user of the VR device that has been detected by the biosensor, and biometric data of a non-skill-possessing user of the VR device that has been detected by the biosensor, the storage means generates and stores time-series data of the biometric information of the skill-possessing user of the VR device from the biometric information of the skill-possessing user of the VR device that has been acquired by the acquisition means, and generates and stores time-series data of the biometric information of the non-skill-possessing user of the VR device from the biometric information of the non-skill-possessing user of the VR device that has been acquired by the acquisition means, and the analysis means estimates and visualizes a change in a time-series of a concentration level of the skill-possessing user of the VR device from the time-series data of the biometric information of the skill-possessing user of the VR device that is stored in the storage means, estimates and visualizes a change in a time-series of a concentration level of the non-skill-possessing user of the VR device from the time-series data of the biometric information of the non-skill-possessing user of the VR device that is stored in the storage means, and compares the visualized change in the time-series data of the concentration level of the skill-possessing user of the VR device, and the visualized change in the time-series data of the concentration level of the non-skill-possessing user of the VR device.
(Supplementary note 32) The work analysis device according to supplementary note 26, wherein the analysis means estimates a stress level of the user of the VR device from the biometric information of the user of the VR device that has been detected by the biosensor.
(Supplementary note 33) The work analysis device according to supplementary note 32, wherein the analysis means visualizes the stress level of the user of the VR device.
(Supplementary note 34) The work analysis device according to supplementary note 33, wherein the acquisition means acquires information indicating whether or not the user of the VR device possesses a skill, biometric information of a skill-possessing user of the VR device that has been detected by the biosensor, and biometric data of a non-skill-possessing user of the VR device that has been detected by the biosensor, and the analysis means estimates and visualizes a stress level of the skill-possessing user of the VR device from the biometric information of the skill-possessing user of the VR device that has been acquired by the acquisition means, estimates and visualizes a stress level of the non-skill-possessing user of the VR device from the biometric information of the non-skill-possessing user of the VR device that has been acquired by the acquisition means, and compares the visualized stress level of the skill-possessing user of the VR device and the visualized stress level of the non-skill-possessing user of the VR device.
(Supplementary note 35) The work analysis device according to supplementary note 1, wherein the acquisition means acquires biometric information of the user of the VR device that has been detected by a biosensor, the storage means generates and stores time-series data of the biometric information of the user of the VR device from the biometric information of the user of the VR device that has been acquired by the acquisition means, and the analysis means estimates and analyzes a change in a time-series of a stress level of the user of the VR device from the time-series data of the biometric information of the user of the VR device that is stored in the storage means.
(Supplementary note 36) The work analysis device according to supplementary note 35, wherein the acquisition means acquires information indicating whether or not the user of the VR device possesses a skill, biometric information of a skill-possessing user of the VR device that has been detected by the biosensor, and biometric data of a non-skill-possessing user of the VR device that has been detected by the biosensor, the storage means generates and stores time-series data of the biometric information of the skill-possessing user of the VR device from the biometric information of the skill-possessing user of the VR device that has been acquired by the acquisition means, and generates and stores time-series data of the biometric information of the non-skill-possessing user of the VR device from the biometric information of the non-skill-possessing user of the VR device that has been acquired by the acquisition means, and the analysis means estimates and visualizes a change in a time-series of a stress level of the skill-possessing user of the VR device from the time-series data of the biometric information of the skill-possessing user of the VR device that is stored in the storage means, estimates and visualizes a change in a time-series of a stress level of the non-skill-possessing user of the VR device from the time-series data of the biometric information of the non-skill-possessing user of the VR device that is stored in the storage means, and compares the visualized change in the time-series data of the stress level of the skill-possessing user of the VR device, and the visualized change in the time-series data of the stress level of the non-skill-possessing user of the VR device.
(Supplementary note 37) The work analysis device according to supplementary note 1, wherein the analysis means analyzes an emotion of the user of the VR device from biometric information of the user of the VR device that has been detected by a biosensor.
(Supplementary note 38) The work analysis device according to supplementary note 37, wherein the acquisition means acquires information indicating whether or not the user of the VR device possesses a skill, biometric information of a skill-possessing user of the VR device that has been detected by the biosensor, and biometric data of a non-skill-possessing user of the VR device that has been detected by the biosensor, and the analysis means analyzes an emotion of the skill-possessing user of the VR device from the biometric information of the skill-possessing user of the VR device that has been acquired by the acquisition means, analyzes an emotion of the non-skill-possessing user of the VR device from the biometric information of the non-skill-possessing user of the VR device that has been acquired by the acquisition means, and compares the emotion of the skill-possessing user of the VR device and the emotion of the non-skill-possessing user of the VR device.
(Supplementary note 39) The work analysis device according to supplementary note 1, wherein the acquisition means acquires biometric information of the user of the VR device that has been detected by a biosensor, the storage means generates and stores time-series data of the biometric information of the user of the VR device from the biometric information of the user of the VR device that has been acquired by the acquisition means, and the analysis means determines, based on the time-series data of the motions made by the user of the VR device that is stored in the storage means, whether or not the user of the VR device has failed at any of the plurality of work items performed in the virtual space, and extracts, in a case where the user of the VR device has failed at any of the plurality of work items performed in the virtual space, a change in the biometric information of the user of the VR device at a timing in which the user of the VR device failed at any of the plurality of work items performed in the virtual space, based on the time-series data of the biometric information of the user of the VR device and the time-series data of the motions made by the user of the VR device that are stored in the storage means.
(Supplementary note 40) The work analysis device according to supplementary note 1, wherein the acquisition means acquires biometric information of the user of the VR device that has been detected by a biosensor, the storage means generates and stores time-series data of the biometric information of the user of the VR device from the biometric information of the user of the VR device that has been acquired by the acquisition means, and the analysis means determines, based on the time-series data of the motions made by the user of the VR device that is stored in the storage means, whether or not the user of the VR device has succeeded at any of the plurality of work items performed in the virtual space, and extracts, in a case where the user of the VR device has succeeded at any of the plurality of work items performed in the virtual space, a change in the biometric information of the user of the VR device at a timing in which the user of the VR device succeeded at any of the plurality of work items performed in the virtual space, based on the time-series data of the biometric information of the user of the VR device and the time-series data of the motions made by the user of the VR device that are stored in the storage means.
(Supplementary note 41) A work analysis system comprising: a VR device that presents a plurality of work items of a problem in a virtual space; and a work analysis device that analyzes the plurality of work items performed by a user of the VR device, wherein the VR device detects motions that are made by the user of the VR device to perform the plurality of work items in the virtual space, and a line of sight direction of the user of the VR device, and the work analysis device comprises: an acquisition means that acquires data representing motions that have been detected by the VR device and which are made by the user of the VR device to perform the plurality of work items in the virtual space, and data representing a line of sight direction of the user of the VR device that has been detected by the VR device; a storage means that generates and stores time-series data of the motions made by the user of the VR device from the data representing the motions made by the user of the VR device to perform the plurality of work items in the virtual space that has been acquired by the acquisition means, and generates and stores time-series data of the line of sight direction of the user of the VR device from the data representing the line of sight direction of the user of the VR device that has been acquired by the acquisition means; an analysis means that visualizes changes in the motions made by the user of the VR device to perform the plurality of work items in the virtual space based on at least the time-series data of the motions made by the user of the VR device that is stored in the storage means, and visualizes changes in the line of sight direction of the user of the VR device based on the time-series data of the line of sight direction of the user of the VR device that is stored in the storage means; and an output means that outputs an analysis result by the analysis means.
(Supplementary note 42) A work analysis method comprising: an acquisition step of acquiring data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device; a storage step of generating and storing time-series data of the motions made by the user of the VR device from the data representing the motions made by the user of the VR device to perform the plurality of work items in the virtual space that has been acquired in the acquisition step, and generating and storing time-series data of the line of sight direction of the user of the VR device from the data representing the line of sight direction of the user of the VR device that has been acquired in the acquisition step; an analysis step of visualizing changes in the motions made by the user of the VR device to perform the plurality of work items in the virtual space based on at least the time-series data of the motions made by the user of the VR device that has been stored in the storage step, and visualizing changes in the line of sight direction of the user of the VR device based on the time-series data of the line of sight direction of the user of the VR device that has been stored in the storage step; and an output step of outputting an analysis result in the analysis step.
(Supplementary note 43) A recording medium that stores a program for causing a computer to execute the steps of: an acquisition step of acquiring data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device; a storage step of generating and storing time-series data of the motions made by the user of the VR device from the data representing the motions made by the user of the VR device to perform the plurality of work items in the virtual space that has been acquired in the acquisition step, and generating and storing time-series data of the line of sight direction of the user of the VR device from the data representing the line of sight direction of the user of the VR device that has been acquired in the acquisition step; an analysis step of visualizing changes in the motions made by the user of the VR device to perform the plurality of work items in the virtual space based on at least the time-series data of the motions made by the user of the VR device that has been stored in the storage step, and visualizing changes in the line of sight direction of the user of the VR device based on the time-series data of the line of sight direction of the user of the VR device that has been stored in the storage step; and an output step of outputting an analysis result in the analysis step.

### INDUSTRIAL APPLICABILITY

The work analysis device, the work analysis system, the work analysis method, and the recording medium of the present invention are applicable to training and the like in which a VR device is used to perform a plurality of work items of a problem in a virtual space.

### Description of Reference Symbols

1 Work analysis system
11 VR device
11A Presentation means
11B Motion detection means
11C Line of sight direction detection means
11D Communication means
11E Posture estimation means
11F Speech estimation means
12 Biosensor
12A Detection means
12B Communication means
13 Work analysis device
13A Communication means
13B Acquisition means
13C Storage means
13D Analysis means
13E Output means

What is claimed is:

1. A work analysis device comprising:
a memory configured to store instructions; and
a processor configured to execute the instructions to:
acquire data representing motions that have been detected by a virtual reality (VR) VR device that presents a plurality of work items of a problem in a virtual space, and which are made by a user of the VR device to perform the plurality of work items in the virtual space, and data representing a line of sight direction of the user of the VR device that has been detected by the VR device;
generate and store time-series data of the motions made by the user of the VR device from the acquired data representing the motions made by the user of the VR device to perform the plurality of work items in the virtual space, and generate and store time-series data of the line of sight direction of the user of the VR device from the acquired data representing the line of sight direction of the user of the VR device;
visualize changes in the motions made by the user of the VR device to perform the plurality of work items in the virtual space based on at least the stored time-series data of the motions made by the user of the VR device, and visualize changes in the line of sight direction of the user of the VR device based on the stored time-series data of the line of sight direction of the user of the VR device; and
output an analysis result.

2. The work analysis device according to claim 1, wherein the processor is configured to execute the instructions to generate a trajectory of execution positions of the plurality of work items performed by the user of the VR device in the virtual space based on the stored time-series data of the motions made by the user of the VR device.

3. The work analysis device according to claim 2, wherein
the processor is configured to execute the instructions to acquire data representing motions that have been detected by the VR device and which are made by one user of the VR device to perform the plurality of work items in the virtual space, and data representing motions that have been detected by the VR device and which are made by another user of the VR device to perform the plurality of work items in the virtual space,
the processor is configured to execute the instructions to generate and store time-series data of the motions made by the one user of the VR device from the acquired data representing the motions made by the one user of the VR device to perform the plurality of work items in the virtual space, and generate and store time-series data of the motions made by the other user of the VR device from the acquired data representing the motions made by the other user of the VR device to perform the plurality of work items in the virtual space, and
the processor is configured to execute the instructions to
generate a trajectory of execution positions of the plurality of work items performed by the one user of the VR device in the virtual space based on the stored time-series data of the motions made by the one user of the VR device,
generate a trajectory of execution positions of the plurality of work items performed by the other user of the VR device in the virtual space based on the stored time-series data of the motions made by the other user of the VR device, and
compare the trajectory of the execution positions of the plurality of work items performed by the one user of the VR device in the virtual space and the trajectory of the execution positions of the plurality of work items performed by the other user of the VR device in the virtual space.

4. The work analysis device according to claim 2, wherein
the processor is configured to execute the instructions to acquire information indicating whether the user of the VR device is right-handed or left-handed,
the processor is configured to execute the instructions to acquire data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space,
the processor is configured to execute the instructions to generate and store time-series data of the motions made by the right-handed user of the VR device from the acquired data representing the motions made by the right-handed user of the VR device to perform the plurality of work items in the virtual space, and generate and store time-series data of the motions made by the left-handed user of the VR device from the acquired data representing the motions made by the left-handed user of the VR device to perform the plurality of work items in the virtual space, and
the processor is configured to execute the instructions to
generate a trajectory of execution positions of the plurality of work items performed by the right-handed user of the VR device in the virtual space based on the stored time-series data of the motions made by the right-handed user of the VR device,
generate a trajectory of execution positions of the plurality of work items performed by the left-handed user of the VR device in the virtual space based on the stored time-series data of the motions made by the left-handed user of the VR device, and
compare the trajectory of the execution positions of the plurality of work items performed by the right-handed user of the VR device in the virtual space and the trajectory of the execution positions of the plurality of work items performed by the left-handed user of the VR device in the virtual space.

5. The work analysis device according to claim 2, wherein
the processor is configured to execute the instructions to acquire information indicating whether or not a user of the VR device possesses a skill, data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space,
the processor is configured to execute the instructions to generate and store time-series data of the motions made by the skill-possessing user of the VR device from the acquired data representing the motions made by the skill-possessing user of the VR device to perform the plurality of work items in the virtual space, and generate and store generates and stores time-series data of the motions made by the non-skill-possessing user of the VR device from the acquired data representing the motions made by the non-skill-possessing user of the VR device to perform the plurality of work items in the virtual space, and
the processor is configured to execute the instructions to generate a trajectory of execution positions of the plurality of work items performed by the skill-possessing user of the VR device in the virtual space based on the stored time-series data of the motions made by the skill-possessing user of the VR device,
generate a trajectory of execution positions of the plurality of work items performed by the non-skill-possessing user of the VR device in the virtual space based on the stored time-series data of the motions made by the non-skill-possessing user of the VR device, and
compare the trajectory of the execution positions of the plurality of work items performed by the skill-possessing user of the VR device in the virtual space and the trajectory of the execution positions of the plurality of work items performed by the non-skill-possessing user of the VR device in the virtual space.

6. The work analysis device according to claim 5, wherein
the processor is configured to execute the instructions to acquire data representing motions that have been detected by the VR device which are made by each of a plurality of skill-possessing users of the VR device to perform the plurality of work items in the virtual space,
the processor is configured to execute the instructions to generate and store time-series data of the motions made by each of the plurality of skill-possessing users of the VR device from the acquired data representing the motions made by each of the plurality of skill-possessing users of the VR device to perform the plurality of work items in the virtual space, and
the processor is configured to execute the instructions to
generate trajectories of execution positions of the plurality of work items performed by each of the plurality of skill-possessing users of the VR device in the virtual space based on the stored time-series data of the motions made by each of the plurality of skill-possessing users of the VR device, and
extract and visualize a trajectory that satisfies a first condition from the trajectories of the plurality of skill-possessing users of the VR device.

7. The work analysis device according to claim 5, wherein
the processor is configured to execute the instructions to acquire data representing motions that have been detected by the VR device which are made by each of a plurality of skill-possessing users of the VR device to perform the plurality of work items in the virtual space,
the processor is configured to execute the instructions to generate and store time-series data of the motions made by each of the plurality of skill-possessing users of the VR device from the acquired data representing the motions made by each of the plurality of skill-possessing users of the VR device to perform the plurality of work items in the virtual space, and
the processor is configured to execute the instructions to
generate trajectories of execution positions of the plurality of work items performed by each of the plurality of skill-possessing users of the VR device in the virtual space based on the stored time-series data of the motions made by each of the plurality of skill-possessing users of the VR device, and
extract trajectories, from the trajectories of the plurality of skill-possessing users, that satisfy a second condition in which an execution order of the work items has a same tendency, and group and assemble the extracted trajectories into tabular data.

8. The work analysis device according to claim 5, wherein
the processor is configured to execute the instructions to acquire data representing motions that have been detected by the VR device which are made by each of a plurality of skill-possessing users of the VR device to perform the plurality of work items in the virtual space,
the processor is configured to execute the instructions to generate and store time-series data of the motions made by each of the plurality of skill-possessing users of the VR device from the acquired data representing the motions made by each of the plurality of skill-possessing users of the VR device to perform the plurality of work items in the virtual space, and
the processor is configured to execute the instructions to
generate trajectories of execution positions of the plurality of work items performed by each of the plurality of skill-possessing users of the VR device in the virtual space based on the stored time-series data of the motions made by each of the plurality of skill-possessing users of the VR device, and
extract, from the trajectories of the plurality of skill-possessing users of the VR device, an execution position of a first work item and an execution position of a final work item for a predetermined proportion or more of the trajectories.

9. The work analysis device according to claim 8, wherein
the processor is configured to execute the instructions to acquire information indicating whether the user of the VR device is right-handed or left-handed, data representing motions that have been detected by the VR device which are made by each of the plurality of skill-possessing right-handed users of the VR device to perform the plurality of work items in the virtual space, and data representing motions that have been detected by the VR device which are made by each of the plurality of skill-possessing left-handed users of the VR device to perform the plurality of work items in the virtual space,
the processor is configured to execute the instructions to generate and store time-series data of the motions made by each of the plurality of skill-possessing right-handed users of the VR device from the acquired data representing the motions made by each of the plurality of skill-possessing right-handed users of the VR device to perform the plurality of work items in the virtual space, and generate and store time-series data of the motions made by each of the plurality of skill-possessing left-handed users of the VR device from the acquired data representing the motions made by each of the plurality of skill-possessing left-handed users of the VR device to perform the plurality of work items in the virtual space, and
the processor is configured to execute the instructions to
generate trajectories of execution positions of the plurality of work items performed by each of the plurality of skill-possessing right-handed users of the VR device in the virtual space based on the stored time-series data of the motions made by each of the plurality of skill-possessing right-handed users of the VR device, and generate trajectories of execution positions of the plurality of work items performed by each of the plurality of skill-possessing left-handed users of the VR device in the virtual space based on the stored time-series data of the motions made by each of the plurality of skill-possessing left-handed users of the VR device, and
extract, from the trajectories of the plurality of skill-possessing right-handed users of the VR device, an execution position of a first work item and an execution position of a final work item for the predetermined proportion or more of the trajectories, and extracts, from the trajectories of the plurality of skill-possessing left-handed users of the VR device, an execution position of a first work item and an execution position of a final work item for the predetermined proportion or more of the trajectories.

10. The work analysis device according to claim 1, wherein
the processor is configured to execute the instructions to acquire information indicating a correct execution order, which is an execution order that is correct for a plurality of work items of a problem that has been specified in advance,
the processor is configured to execute the instructions to store the acquired information indicating the correct execution order, and
the processor is configured to execute the instructions to determine whether or not an execution order of the plurality of work items performed by the user of the VR device in the virtual space matches the correct execution order.

11. The work analysis device according to claim 10, wherein
the processor is configured to execute the instructions to acquire information indicating whether or not the user of the VR device possesses a skill, data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space,
the processor is configured to execute the instructions to generate and store time-series data of the motions made by the skill-possessing user of the VR device from the acquired data representing the motions made by the skill-possessing user of the VR device to perform the plurality of work items in the virtual, and generate and store time-series data of the motions made by the non-skill-possessing user of the VR device from the acquired data representing the motions made by the non-skill-possessing user of the VR device to perform the plurality of work items in the virtual space, and
the processor is configured to execute the instructions to
determine whether or not an execution order of the plurality of work items performed by the skill-possessing user of the VR device in the virtual space matches the correct execution order,
determine whether or not an execution order of the plurality of work items performed by the non-skill-possessing user of the VR device in the virtual space matches the correct execution order, and
compare a determination result of whether or not the execution order of the plurality of work items performed by the skill-possessing user of the VR device in the virtual space matches the correct execution order, and a determination result of whether or not the execution order of the plurality of work items performed by the non-skill-possessing user of the VR device in the virtual space matches the correct execution order.

12. The work analysis device according to claim 10, wherein
the processor is configured to execute the instructions to acquire information indicating whether the user of the VR device is right-handed or left-handed, data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space,
the processor is configured to execute the instructions to generate and store time-series data of the motions made by the right-handed user of the VR device from the acquired data representing the motions made by the right-handed user of the VR device to perform the plurality of work items in the virtual space, and generate and store time-series data of the motions made by the left-handed user of the VR device from the acquired data representing the motions made by the left-handed user of the VR device to perform the plurality of work items in the virtual space, and
the processor is configured to execute the instructions to
determine whether or not an execution order of the plurality of work items performed by the right-handed user of the VR device in the virtual space matches the correct execution order,
determine whether or not an execution order of the plurality of work items performed by the left-handed user of the VR device in the virtual space matches the correct execution order, and
compare a determination result of whether or not the execution order of the plurality of work items performed by the right-handed user of the VR device in the virtual space matches the correct execution order, and a determination result of whether or not the execution order of the plurality of work items performed by the left-handed user of the VR device in the virtual space matches the correct execution order.

13. The work analysis device according to claim 1, wherein
the processor is configured to execute the instructions to acquire information indicating a first correct execution order, which is an execution order that is correct for first and subsequent work items from among the plurality of work items of the problem, and information indicating a second correct execution order, which is an execution order that is correct for second and subsequent work items,
the processor is configured to execute the instructions to store the acquired information indicating the first correct execution order and the acquired information indicating the second correct execution order, and
the processor is configured to execute the instructions to
determine whether or not an execution order of a plurality of work items including the first and subsequent work items performed by the user of the VR device in the virtual space matches the first correct execution order, and whether or not an execution order of a plurality of work items including the second and subsequent work items performed by the user of the VR device in the virtual space matches the second correct execution order.

14. The work analysis device according to claim 10, wherein the processor is configured to execute the instructions to determine, for each execution position of the work items, whether or not the execution order of the plurality of work items performed by the user of the VR device in the virtual space matches the correct execution order.

15. The work analysis device according to claim 14, wherein
the processor is configured to execute the instructions to acquire information indicating whether the user of the VR device is right-handed or left-handed, data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space,
the processor is configured to execute the instructions to generate and store time-series data of the motions made by the right-handed user of the VR device from the acquired data representing the motions made by the right-handed user of the VR device to perform the plurality of work items in the virtual space, and generate and store time-series data of the motions made by the left-handed user of the VR device from the acquired data representing the motions made by the left-handed user of the VR device to perform the plurality of work items in the virtual space, and
the processor is configured to execute the instructions to
determine, for each execution position of the work items, whether or not the execution order of the plurality of work items performed by the right-handed user of the VR device in the virtual space matches the correct execution order, and
determine, for each execution position of the work items, whether or not the execution order of the plurality of work items performed by the left-handed user of the VR device in the virtual space matches the correct execution order.

16. The work analysis device according to claim 14, wherein
the processor is configured to execute the instructions to acquire information indicating whether or not the user of the VR device possesses a skill, data representing motions that have been detected by the VR device and which are made by a skill-possessing user of the VR device to perform the plurality of work items in the virtual space, and data representing motions that have been detected by the VR device and which are made by a non-skill-possessing user of the VR device to perform the plurality of work items in the virtual space,
the processor is configured to execute the instructions to generate and store time-series data of the motions made by the skill-possessing user of the VR device from the data representing the motions made by the skill-possessing user of the VR device to perform the plurality of work items in the virtual space that has been acquired by the acquisition means, and generate and store time-series data of the motions made by the non-skill-possessing user of the VR device from the acquired data representing the motions made by the non-skill-possessing user of the VR device to perform the plurality of work items in the virtual space, and
the processor is configured to execute the instructions to
determine, for each execution position of the work items, whether or not the execution order of the plurality of work items performed by the skill-possessing user of the VR device in the virtual space matches the correct execution order,
determine, for each execution position of the work items, whether or not the execution order of the plurality of work items performed by the non-skill-possessing user of the VR device in the virtual space matches the correct execution order, and
compare, for each execution position of the work items, a determination result of whether or not the execution order of the plurality of work items performed by the skill-possessing user of the VR device in the virtual space matches the correct execution order, and a determination result of whether or not the execution order of the plurality of work items performed by the non-skill-possessing user of the VR device in the virtual space matches the correct execution order.

17. The work analysis device according to claim 10, wherein
the processor is configured to execute the instructions to
determine whether or not the execution order of the plurality of work items performed by each of the plurality of users of the VR device in the virtual space matches the correct execution order, and
extract, from among the plurality of work items of the problem, a work item in which a probability of each of the plurality of users of the VR device performing an execution order that is different from the correct execution order is higher than a predetermined threshold.

18. The work analysis device according to claim 17, wherein
the processor is configured to execute the instructions to acquire information indicating whether the user of the VR device is right-handed or left-handed, data representing motions that have been detected by the VR device and which are made by a right-handed user of the VR device to perform the plurality of work items in the virtual space, and data representing motions that have been detected by the VR device and which are made by a left-handed user of the VR device to perform the plurality of work items in the virtual space,
the processor is configured to execute the instructions to generate and store time-series data of the motions made by the right-handed user of the VR device from the data representing the motions made by the right-handed user of the VR device to perform the plurality of work items in the virtual space that has been acquired by the acquisition means, and generates and stores time-series data of the motions made by the left-handed user of the VR device from the acquired data representing the motions made by the left-handed user of the VR device to perform the plurality of work items in the virtual space, and
the processor is configured to execute the instructions to
determine whether or not the execution order of the plurality of work items performed by each of the plurality of right-handed users of the VR device in the virtual space matches the correct execution order,
extract, from among the plurality of work items of the problem, work items in which a probability of each of the plurality of right-handed users of the VR device performing an execution order that is different from the correct execution order is higher than the predetermined threshold,
determine whether or not the execution order of the plurality of work items performed by each of the plurality of left-handed users of the VR device in the virtual space matches the correct execution order, and
extract, from among the plurality of work items of the problem, work items in which a probability of each of the plurality of left-handed users of the VR device performing an execution order that is different from the correct execution order is higher than the predetermined threshold.

19-40. (canceled)

41. A work analysis system comprising:
a virtual reality (VR) device configured to present a plurality of work items of a problem in a virtual space; and
a work analysis device configured to analyze the plurality of work items performed by a user of the VR device, wherein
the VR device is configured to detect motions that are made by the user of the VR device to perform the plurality of work items in the virtual space, and a line of sight direction of the user of the VR device, and
the work analysis device comprises:
a memory configured to store instructions; and
a processor configured to execute the instructions to:
acquire data representing motions that have been detected by the VR device and which are made by the user of the VR device to perform the plurality of work items in the virtual space, and data representing a line of sight direction of the user of the VR device that has been detected by the VR device;
generate and store time-series data of the motions made by the user of the VR device from the acquire data representing the motions made by the user of the VR device to perform the plurality of work items in the virtual space, and generate and store time-series data of the line of sight direction of the user of the VR device from the acquired data representing the line of sight direction of the user of the VR device;
visualize changes in the motions made by the user of the VR device to perform the plurality of work items in the virtual space based on at least the stored time-series data of the motions made by the user of the VR device, and visualize changes in the line of sight direction of the user of the VR device based on the stored time-series data of the line of sight direction of the user of the VR device; and
output an analysis result.

42. A work analysis method comprising:
acquiring data representing motions that have been detected by a VR device that presents a plurality of work items of a problem in a virtual space, and which are made by a user of the VR device to perform the plurality of work items in the virtual space, and data representing a line of sight direction of the user of the VR device that has been detected by the VR device;
generating and storing time-series data of the motions made by the user of the VR device from the acquired data representing the motions made by the user of the VR device to perform the plurality of work items in the virtual space, and generating and storing time-series data of the line of sight direction of the user of the VR device from the acquired data representing the line of sight direction of the user of the VR device;
visualizing changes in the motions made by the user of the VR device to perform the plurality of work items in the virtual space based on at least the stored time-series data of the motions made by the user of the VR device, and visualizing changes in the line of sight direction of the user of the VR device based on the stored time-series data of the line of sight direction of the user of the VR device; and
outputting an analysis result in the analysis step.

43. (canceled)
